(19) United States
(12) Patent Application Publication
(10) Pub. No.: US 2026/0056861 A1
(43) Pub. Date: Feb. 26, 2026

(54) IDENTIFYING SOURCES OF PERFORMANCE VARIABILITY USING RELEVANT PERFORMANCE DATA

(71) Applicant: Microsoft Technology Licensing, LLC, Redmond, WA (US)

(72) Inventors: Amritam SARCAR, Sammamish, WA (US); Andrew J. Ritz, Sammamish, WA (US); Michael David Decker, Redmond, WA (US); Javier Nisim Flores Assad, Bothell, WA (US)

(21) Appl. No.: 18/812,266

(22) Filed: Aug. 22, 2024

(51) Int. Cl. G06F 11/34

(52) U.S. Cl. CPC G06F 11/3409; G06F 11/3476

(57) ABSTRACT

Methods, computer systems, and computer storage media are provided for identifying a source(s) of performance variability using relevant performance data. In embodiments, performance data indicating performance of a computing system is obtained. Such performance data is analyzed to identify relevant performance data including a representation of a differential graph that compares a first set of performance data associated with a first environment with a second set of performance data associated with second environment. Thereafter, a prompt is generated that includes the representation of the differential graph and a request for an identification of a source of performance variability associated with the relevant performance data. Based on the prompt, the source of performance variability associated with the relevant performance data may be identified via a large language model and provided for display.

### BACKGROUND

To identify performance issues or bottlenecks in association with a computer system, or a portion thereof, traces from client machines are oftentimes manually reviewed. To focus on a relevant or particular portion of importance, however, is very difficult and time consuming. For example, the number of traces to review may be extensive with numerous details provided in each trace. Further, traces often contain irrelevant and duplicative information, thereby adding to the complexity of identifying relevant information for understanding performance issues.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various aspects of the technology described herein are generally directed to systems, methods, and computer storage media for identifying a source of performance variability using relevant performance data. In this regard, the technology described herein facilitates identifying suitable or relevant performance data to provide for analysis in identifying a source of performance variability. In this way, the identified relevant performance data may be provided in a prompt for a large language model (LLM) to evaluate and provide a response indicating a source of performance variability. Using a more focused or specific set of performance data for identifying a source of performance variability enables a more computationally efficient and effective implementation.

### BRIEF DESCRIPTION OF DRAWINGS

The technology described herein is described in detail below with reference to the attached drawing figures, wherein:

FIG. 1 is a block diagram of an exemplary system for identifying a source of performance variability using relevant performance data, suitable for use in implementing aspects of the technology described herein;

FIG. 2A is an example implementation for identifying a source of performance variability using relevant performance data, in accordance with aspects of the technology described herein;

FIG. 2B is an example flow of a data transformation, in accordance with embodiments described herein;

FIGS. 3A-3C provide example matrices representing differential graphs, in accordance with aspects of the technology described herein;

FIGS. 4A-4D provide example prompts, in accordance with aspects of the technology described herein;

FIG. 5 provides an example method flow for identifying a source of performance variability using relevant performance data, in accordance with aspects of the technology described herein;

FIG. 6 provides another example method flow for identifying a source of performance variability using relevant performance data, in accordance with embodiments described herein;

FIG. 7 is a block diagram of an exemplary computing environment suitable for use in implementing aspects of the technology described herein; and

FIG. 8 is a block diagram of an exemplary large language model environment suitable for use in implementing aspects of the technology described herein.

### DETAILED DESCRIPTION

The technology described herein is described with specificity to meet statutory requirements. However, the description itself is not intended to limit the scope of this patent. Rather, the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

### Overview

Performance variability generally refers to an occurrence or extent to which performance of a computing device, system, network, and/or application varies over time. In this regard, performance variability corresponds with a change or difference in performance observations, such as regressions and/or improvements. Oftentimes, performance variability corresponds with a performance issue or problem due to various internal or external factors. Such performance variability may manifest, for example, in terms of response times, throughput, resource utilization, error rates, and/or overall system stability.

To identify root causes or sources of performance variability in association with a computing device, application, system, network, or the like, traces are oftentimes obtained and analyzed. A trace generally refers to a chronological record or log of events, actions, or operations within a software application, system, or network. Traces may be used for monitoring, debugging, performance analysis, and/or auditing purposes. A trace may capture events or activities that occur during the execution of a program or operation. For instance, a trace may include function calls, method invocations, system-level operations, user interactions, network requests, responses, and/or the like. Events in a trace are generally recorded in sequential order reflecting timing and sequence of operations as they occur over time. Each event in a trace may be accompanied by additional context information or metadata, such as timestamps, parameters passed to functions, error codes, resource usage metrics, and other details. Accordingly, traces may be analyzed to, among other things, identify and diagnose software bugs, errors, or unexpected behaviors; analyze system performance metrics such as response times, latency, throughput, and resource utilization; track user actions or system activities; and/or understand usage patterns, user interactions, or application workflows.

While analyzing traces, or other performance data, may be valuable to identify a source or root cause of performance variability (e.g., a computing performance issue), such analysis may be difficult and tedious. For example, traces oftentimes include a large amount of data. In addition to the extensive volume of data, traces may include detailed information and redundant or irrelevant information (e.g., that may obscure critical data needed for analysis). As such, manually reviewing (e.g., via a subject matter expert) traces or other performance data to identify a source or root cause of a performance issue is tedious, time consuming, and error prone, particularly as the number of traces increases.

Further, manual reviewing of traces, or other performance data, may unnecessarily consume computing resources. For example, as traces often contain an extensive amount of data, processing and reviewing such large datasets can be computationally intensive. Further, manual review typically involves repeated querying, filtering, and processing of trace data, which is also generally resource intensive. As one example, the same trace data may need to be repeatedly analyzed with different criteria or focus areas, resulting in redundant computation. Moreover, as manual analysis is often a lengthy process, such a process causes prolonged periods where resources are actively engaged, thereby reducing computing resource availability for other processes and tasks.

As such, in accordance with embodiments described herein, the present technology uses artificial intelligence (AI) technology, such as a large language model (LLM), to facilitate analysis of performance data, such as traces. In particular, AI technology may be used to identify a source of performance data variability. As performance data, such as traces, may be extensive in length and quantity, providing such performance data as input to a large language model may be difficult and ineffective. For example, a prompt input into a large language model generally corresponds with a maximum prompt size (e.g., measured in terms of a number of tokens, such as 8,000 tokens). Including various traces in an input prompt for analysis may exceed the maximum token limit. Further, responses generated by an LLM may be more effective with data specificity and/or context provided in the prompt. Without focusing on particular data, an LLM may produce hallucinations. Accordingly, providing complete traces in a prompt may result in hallucinations.

Further, in addition to resulting in hallucinations, a prompt including vague information may also unnecessarily use computing resources. For example, vague or unfocused prompts require the LLM to process more information to generate a relevant response, which may increase the computation time needed for the model to produce an output. Further, vague prompts often lead to longer, more verbose inputs, which increases the number of tokens needed to be processed and therefore more computational resources. As another example, managing a broader context can increase the memory footprint required for processing the prompt as well as consuming additional memory resources to generate and store more intermediate results when trying to interpret a vague prompt. Moreover, vague prompts often necessitate multiple rounds of interaction to clarify the user's intent, with each interaction consuming additional computation resources.

As such, embodiments described herein facilitate identifying suitable or relevant performance data to provide for analysis in identifying a source of performance variability. In this way, the identified relevant performance data may be provided in a prompt for an LLM to evaluate and provide a response indicating a source of performance variability. Using a more focused or specific set of performance data for identifying a source of performance variability enables a more computationally efficient and effective implementation.

To identify relevant performance data, performance data may be obtained in association with different environments, such as a control environment and a treatment environment. In this regard, a first set of performance data may be obtained in association with one environment that includes data corresponding with a performance issue (e.g., traces including increased processing time), and a second set of performance data may be obtained in association with another environment that includes data that does not correspond with the performance issue (e.g., traces including baseline processing time). In accordance with obtaining performance data, commonalities of performance data are identified within the different environments to represent the different environments (e.g., a control environment and a treatment environment). For instance, commonalties among the first set of performance data may be identified, and commonalities among the second set of performance data may be identified. The commonalities for each set of performance data may be represented in a common graph for the corresponding environment. Thereafter, differences between the performance data in the different environments are identified. For instance, a differential graph may be generated (e.g., using the common graphs) that represents differences and, in some cases similarities, between the performance data associated with a control environment and the performance data associated with a treatment environment. Such differences may represent or indicate relevant performance data for identifying a source of performance variability. In embodiments, the differential graph may be transformed into a matrix that indicates or represents relevant performance data for use in identifying a source(s) of data variability.

To identify a source(s) of data variability, a prompt may be generated for input into an AI agent, such as an LLM, to provide a response including an identified source(s) of data variability. In addition to an instruction to identify a source(s) of data variability, the prompt may include the identified relevant portion of performance data for focusing the identification of performance variability sources. For instance, a differential graph, or a matrix representation thereof, may be included in the prompt for focusing identification of performance variability sources based on a reduced set of performance data. In some cases, the prompt may also include structural data to provide additional context for more accurate identification of a data variability source(s).

Based on the input prompt, a response may be obtained indicating a source(s) associated with performance variability. In this way, the response generated may indicate the performance variability source, or potential root cause, of a performance issue or variability in data. A performance variability source may be any source or root cause associated with a performance variability or performance issue. For example, a performance variability source may include a specific portion of code, such as a function or set of functions, or other elements such as system configurations, external dependencies, and/or resource content. In some cases, specific functions or methods in code may be identified as a source of performance variability, for instance, for being inefficient, poorly optimized, or containing bugs that cause performance degradation. In other cases, inefficient loops that execute too many times or perform unnecessary calculations may be identified as a source of performance variability. As yet another example, suboptimal algorithms that do not scale well with increased data or load may be identified as a source of performance variability. Other examples of performance variability sources may include misconfigurations in the operating system, network settings, or application settings that hinder performance, inefficient database queries, inadequate indexing, poor thread management, threads or processes waiting for resources, and/or the like.

The identified performance variability source(s) may then be provided, for example, to a user of a user device or another component for further analysis and/or to resolve or mitigate the performance issue. Understanding the source(s) of performance variability is valuable for diagnosing, troubleshooting, and optimizing the performance of systems and applications. By identifying and addressing these sources, performance fluctuations may be reduced and overall system stability as well as user experience may be improved.

### Overview of Exemplary Environments for Identifying Sources of Performance Variability Using Relevant Performance Data

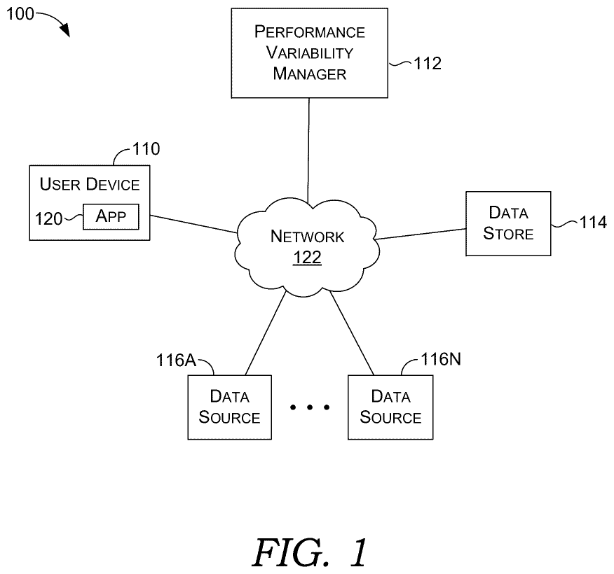

Referring initially to FIG. 1, a block diagram of an exemplary network environment 100 suitable for use in implementing embodiments described herein is shown. Generally, the system 100 illustrates an environment suitable for identifying performance variability sources using relevant performance data. Among other things, embodiments described herein efficiently and effectively identify a source or root cause of performance variability in association with performance of a computing device, system, application, network, and/or the like in an automated manner. To do so efficiently and effectively, a set of relevant performance data is identified and used for identifying a source of performance variability. In particular, identifying relevant performance data reduces the set of data to be analyzed for identifying a performance variability source. In accordance with identifying a set of relevant performance data, such data may be used to identify a performance variability source(s), for example, using AI technology. For instance, a prompt may be generated that includes the relevant performance data (e.g., a differential graph or matrix representation thereof) such that the relevant performance data is analyzed by AI, such as an LLM, to identify a source of performance variability. In this way, a source or root cause resulting in a performance issue may be efficiently and effectively recognized or identified.

The network environment 100 includes a user device 110, a performance variability manager 112, a data store 114, and data sources 116a-116n (referred to generally as data source[s] 116). The user device 110, the performance variability manager 112, the data store 114, and the data sources 116a-116n can communicate through a network 122, which may include any number of networks such as, for example, a local area network (LAN), a wide area network (WAN), the Internet, a cellular network, a peer-to-peer (P2P) network, a mobile network, or a combination of networks. The data store 114 may store any type or amount of data, including data accessible to the user device 110, the performance variability manager 112, and/or the data sources 116. For example, the data store 114 may store prompts, performance data, performance graphs, common graphs, differential graphs, structure graphs, relevant performance data, matrix representations, and/or the like.

The network environment 100 shown in FIG. 1 is an example of one suitable network environment and is not intended to suggest any limitation as to the scope of use or functionality of embodiments disclosed throughout this document, and nor should the exemplary network environment 100 be interpreted as having any dependency or requirement related to any single component or combination of components illustrated therein. For example, the user device 110 and data sources 116a-116n may be in communication with the performance variability manager 112 via a mobile network or the Internet, and the performance variability manager 112 may be in communication with data store 114 via a local area network. Further, although the environment 100 is illustrated with a network, one or more of the components may directly communicate with one another, for example, via HDMI (High-Definition Multimedia Interface) and DVI (Digital Visual Interface). Alternatively, one or more components may be integrated with one another, for example, at least a portion of the performance variability manager 112 and/or data store 114 may be integrated with the user device 110. For instance, a portion of the performance variability manager 112 may be integrated with the user device (e.g., via application 120).

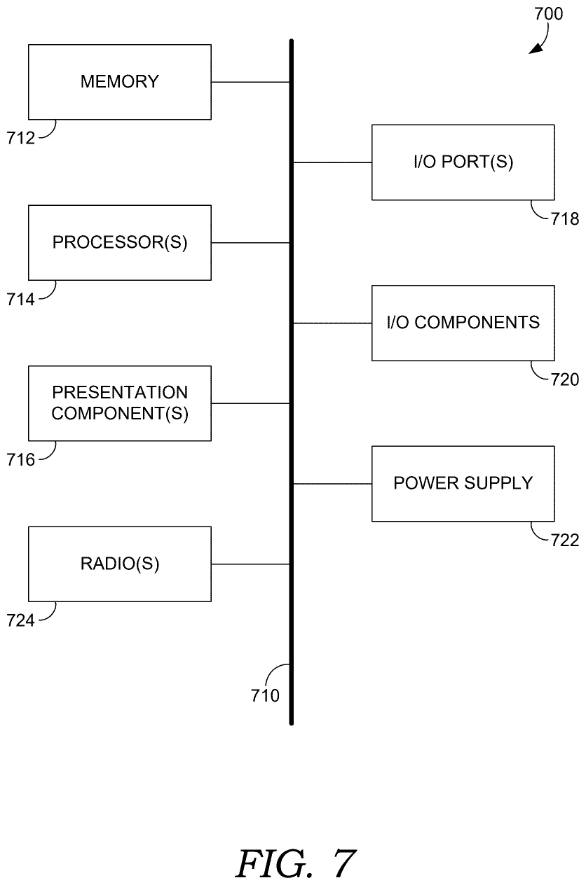

The user device 110 can be any kind of computing device capable of facilitating the identification and/or presentation of sources of performance variability. For example, in an embodiment, the user device 110 can be a computing device such as computing device 700, as described above with reference to FIG. 7. In embodiments, the user device 110 can be a personal computer (PC), a laptop computer, a workstation, a mobile computing device, a PDA, a cell phone, or the like.

The user device can include one or more processors and one or more computer-readable media. The computer-readable media may include computer-readable instructions executable by one or more processors. The instructions may be embodied by one or more applications, such as application 120 shown in FIG. 1. The application(s) may generally be any application capable of facilitating the identification of performance variability. Capabilities to identify performance variability sources may be integrated into a variety of applications across various domains, for example, to enhance productivity, facilitate decision-making, and efficiently automate tasks. Examples of applications may include code editors and integrated development environments, productivity tools and office suites, customer relationship management (CRM) systems, project management software, collaboration platforms, content creation tools, e-commerce platforms, data analysis and business intelligence tools, healthcare applications, or the like. In this regard, in some cases, technology described herein may be used in association with code development and management applications. In other cases, technology described herein may be used in association with other types of applications for which performance analysis may be desired. In yet other cases, technology described herein may be incorporated into an operating system or other system to analyze performance of a computing device, network, system, application, or the like. Any of such applications may include or access an AI assistant tool or technology that may facilitate identifying a source of performance variability. As such, application 120 may be any type of application that may facilitate identification of performance variability sources. In some implementations, the application(s) comprises a web application, which can run in a web browser, and may be hosted at least partially server-side (e.g., via performance variability manager 112). In addition, or instead, the application(s) can comprise a dedicated application. In some cases, the application is integrated into the operating system (e.g., as a service).

User device 110 can be a client device on a client-side of operating environment 100, while performance variability manager 112 can be on a server-side of operating environment 100. Performance variability manager 112 may comprise server-side software designed to work in conjunction with client-side software on user device 110 so as to implement any combination of the features and functionalities discussed in the present disclosure. An example of such client-side software is application 120 on user device 110. This division of operating environment 100 is provided to illustrate one example of a suitable environment, and it is noted that there is no requirement for each implementation that any combination of user device 110 and/or performance variability manager 112 remain as separate entities.

In an embodiment, the user device 110 is separate and distinct from the performance variability manager 112, the data store 114, and the data sources 116 illustrated in FIG. 1. In another embodiment, the user device 110 is integrated with one or more illustrated components. For instance, the user device 110 may incorporate functionality described in relation to the performance variability manager 112. For clarity of explanation, embodiments are described herein in which the user device 110, the performance variability manager 112, the data store 114, and the data sources 116 are separate, while understanding that this may not be the case in various configurations contemplated.

As described, a user device, such as user device 110, can facilitate identification of a source(s) of performance variability using relevant performance data in an effective and efficient manner. A source of performance variability, or a performance variability source, generally refers to a source or root cause of fluctuations or inconsistencies in the performance of a computing system, process, application, or network. As one example, a source may include a portion of code, such as a function(s), a method(s), or the like. Performance variability may affect the efficiency, speed, and/or reliability of applications, systems, and/or networks. Understanding and identifying such sources of performance variability may be critical for optimizing performance and ensuring consistent operation. In this regard, identifying a source(s) of performance variability enables a user or computing system, or portion thereof, to understand a root cause of performance issues, problems, and/or variations. As such, identifying a source of performance variability in an efficient and effective manner facilitates a more productive and effective performance of computing operations (e.g., in association with an application, a computing device, a network, a system, or the like). Embodiments described herein enable the performance variability manager 112 to identify a source(s) of performance variability using relevant performance data to do so in an efficient and effective manner.

A user device 110, as described herein, is generally operated by an individual or entity interested in initiating identification of a source(s) of performance variability and/or viewing such information. In some cases, identification and/or presentation of a source of performance variability may be initiated at the user device 110. For instance, in some cases, a user may navigate to an AI tool interface (e.g., a chat box) and input a request to identify a performance variability source(s). As one example, the user input may include or be a natural language input by a user. A user input may include a request in the form of a question, command, or description of a source identification request. Based on the input, identification and/or presentation of a source(s) of performance variability is initiated. For example, a user may navigate to an application and input a request to identify a source of performance variability associated with a particular issue (e.g., a time or memory increase) to obtain a corresponding response that indicates a source or root cause of the performance variability.

As described, the user device 110 can include any type of application, which may be a stand-alone application, a mobile application, a web application, or the like. In some cases, the functionality described herein may be integrated directly with an application or may be an add-on, or plug-in, to an application.

The user device 110 may communicate with the performance variability manager 112 to initiate identification and/or presentation of performance variability sources. In embodiments, for example, a user may utilize the user device 110 to initiate identification and/or presentation of performance variability sources via the network 122. For instance, in some embodiments, the network 122 may be the Internet, and the user device 110 interacts with the performance variability manager 112 to initiate identification and/or presentation of performance variability sources. In other embodiments, for example, the network 122 may be an enterprise network associated with an organization. In yet other embodiments, the performance variability manager 112 may additionally or alternatively operate locally on the user device 110 to provide local responses. It should be apparent to those having skill in the relevant arts that any number of other implementation scenarios may be possible as well.

With continued reference to FIG. 1, the performance variability manager 112 can be implemented as server system(s), program module(s), virtual machine(s), component(s) of a server or servers, networks, and the like. At a high level, the performance variability manager 112 manages identification of performance variability sources. In embodiments, at a high level, to identify a source(s) associated with performance variability, relevant performance data is determined and used to identify such performance variability sources. To determine relevant performance data, various performance data may be obtained. For example, performance data may be obtained from various data sources, such as data sources 116. Such performance data may be in any number of formats, such as traces, logs, markers, and/or the like. As such, data sources 116 may include various performance data, such as traces, logs, and/or markers. In embodiments, performance data may be obtained in association with different environments, such as a control environment and a treatment environment. In this regard, performance data is obtained in association with one environment that includes data corresponding with a performance issue and another environment that includes data that does not correspond with the performance issue. In accordance with obtaining performance data, commonalities of performance data are identified within different environments to represent the different environments (e.g., a control environment and a treatment environment). Thereafter, differences between the performance data in the different environments are identified. For instance, a differential graph may be generated.

By way of example only, assume a first set of performance traces corresponds with a control environment, and a second set of performance traces corresponds with a treatment environment. In such a case, common traits associated with the first set of performance traces may be identified, and common traits associated with the second set of performances traces may be identified. The common traits associated with the first set of performance traces may then be compared to the common traits associated with the second set of performance traces to identify differences (and, in some cases, similarities) via a differential graph based on the different sets of common traits. Such differences may represent or indicate a relevant set of performance data for identifying a source(s) of performance variability. In embodiments, the differential graph may be transformed into a matrix that indicates or represents relevant performance data for use in identifying a source(s) of data variability.

To identify the source(s) of data variability, a prompt may be generated for input into an AI agent, such as an LLM, to provide a response including an identified source(s) of data variability. Advantageously, the prompt may include the identified relevant portion of performance data for focusing the identification of performance variability sources. For instance, a differential graph, or a matrix representation thereof, may be included in the prompt for focusing identification of performance variability sources. In addition, structural data may be included in the prompt. Based on the input prompt, a response may be generated that indicates a source(s) of performance variability. The performance variability manager 112 may then communicate with application 120 operating on user device 110 to provide an indication of the identified source(s) of performance variability. In this regard, an indication of performance variability source(s) may be provided to the user device for presentation to the user. An indication of performance variability source(s) may be presented to a user via a user interface associated with application 120 in any number of ways. Additionally or alternatively, an indication of performance variability source(s) may be provided to another computing component or system for further analysis and/or automatically refining the source to rectify the performance issue.

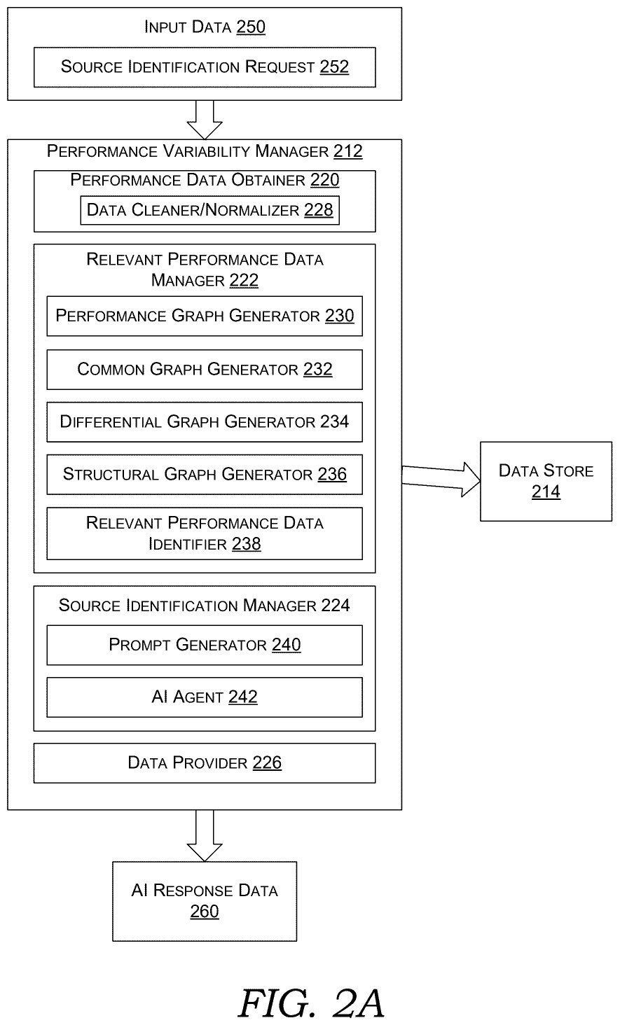

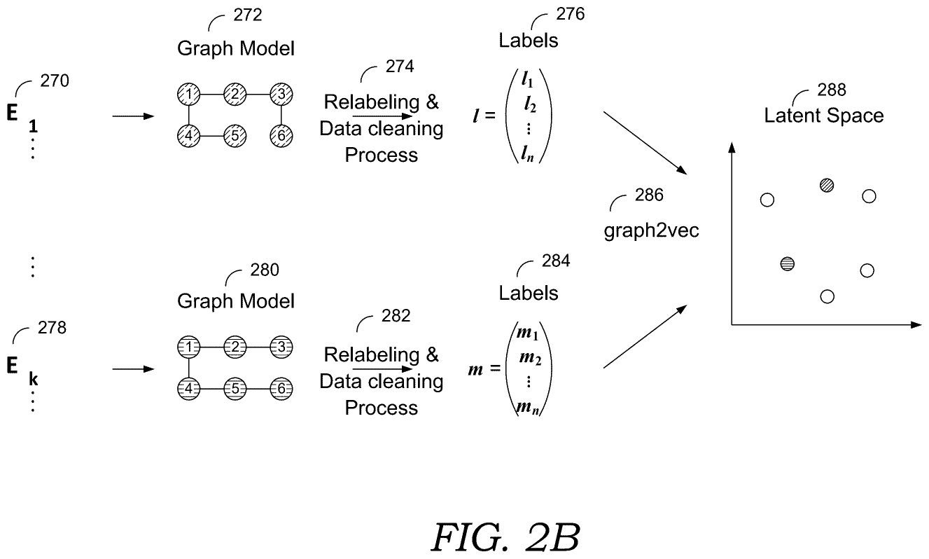

Turning now to FIG. 2A, FIG. 2A illustrates an example implementation for identifying and/or presenting performance variability sources using relevant performance data via performance variability manager 212. The performance variability manager 212 is communicatively coupled with the data store 214. The data store 214 is configured to store various types of information accessible by the performance variability manager 212 or other server or device. In embodiments, data sources (such as data sources 116 of FIG. 1), user devices (such as user devices 110 of FIG. 1), and/or performance variability manager (such as performance variability manager 212) can provide data to the data store 214 for storage, which may be retrieved or referenced by any such component. As such, the data store 214 may store performance data, performance graphs, common graphs, differential graphs, structural graphs, matrix representations, and/or the like.

In operation, the performance variability manager 212 is generally configured to manage identifying and/or presenting performance variability sources using relevant performance data in an efficient and effective manner. In embodiments, the performance variability manager 212 includes a performance data obtainer 220, a relevant performance data manager 222, a source identification manager 224, and a data provider 226. According to embodiments described herein, the performance variability manager 212 can include any number of other components not illustrated. In some embodiments, one or more of the illustrated components 220, 222, 224, and 226 can be integrated into a single component or can be divided into a number of different components. Components 220, 222, 224, and 226 can be implemented on any number of machines and can be integrated, as desired, with any number of other functionalities or services.

At a high level, identification of performance variability sources may be initiated in any number of ways. In some cases, such identification may be initiated based on the performance variability manager 212 receiving a source identification request 252, as input data 250, that requests identification of a performance variability source. In some embodiments, a source identification request may be obtained at the performance variability manager 212 based on user input. For example, a user operating a user device may provide input or select to initiate identification of a performance variability source. In such cases, the user may provide an indication of performance data to utilize in the analysis. For example, the user may specify a particular type of performance data (e.g., traces, logs, or the like) Additionally or alternatively, the user may specify a particular set of performance data, such as performance data exhibiting a particular issue, performance data associated with a particular time duration, performance data associated with a particular system, application or device, and/or the like. Further, in some cases, the user may specify the corresponding environments or clusters associated with performance data. For instance, the user may select a first set of traces for a first environment, such as a control environment, and select a second set of traces for a second environment, such as a treatment environment. In some cases, the user may additionally or alternatively specify a particular performance issue, concern, or data variability associated with performance data from which a source or root cause is desired to be identified. For instance, a user may specify an increased amount of time or memory resource utilization.

Additionally or alternatively, a source identification request, such as source identification request 252, may be automatically triggered based on an occurrence of an event. For example, in accordance with a threshold number of instances of a particular issue occurring in association with performance variability, a source identification request may be automatically triggered to initiate identification of a source of the performance variability. As another example, in accordance with expiration of a time duration (e.g., one day, one week, or the like), a source identification request may be automatically triggered to initiate identification of a source of performance variability.

In accordance with initiating identification of a source of performance variability, the performance data obtainer 220 is generally configured to obtain performance data. Performance data generally refers to any data associated with performance of a computing device, a computing system, an application, a network, or any other computer-related component or aspect. Performance data may relate to any type of performance of computing resources, such as, for example, CPU utilization, memory utilization, disk input/output, network performance, application performance, system uptime, temperature and power consumption, and/or the like.

Performance data may be obtained in any number of forms. As one example, performance data may be obtained in the form of log data. Log data may generally include chronological records of events or activities generated by a system(s), an application(s), and/or a device(s). Various types of logs having log data include system logs (e.g., system-level events such as startup/shutdown, errors, warnings, and informational messages), application logs (e.g., events specific to software applications, such as user interactions, errors, exceptions, and other performance metrics), security logs (e.g., security-related events such as login attempts, access control changes, and potential security breaches), network logs (e.g., network-related events, such as traffic flow, bandwidth usage, packet loss, and network device status), and the like. Any type or combinations of log data may be obtained as performance data.

As another example, performance data may be obtained in the form of traces. Traces may generally include detailed records or individual transactions or activities within a system or application. For instance, a trace, or performance trace, may include indications of events and corresponding times. For instance, at time 0 milliseconds (ms), a first event occurs (e.g., user sends a request to the web application); at time 5 ms, a second event occurs (e.g., web application receives the request); at time 10 ms, a third event occurs (e.g., web application forwards the request to the authentication service); at time 20 ms, a fourth event occurs (e.g., authentication service processes the request, at time 25 ms, a fifth event occurs (e.g., authentication service responds to the web application), and/or the like. Traces may include further details, for example, in association with each event (e.g., user credentials verified, authentication successful, or the like).

Various types of traces may be generated and analyzed including execution traces, system traces, event traces, and/or performance traces. Execution traces may capture the sequence of function calls, method invocations, and/or program flow within an application. System traces may monitor system-level activities, such as CPU, utilization, memory allocation, disk I/O operations, and/or network traffic. Event traces may log specific events or actions initiated by users or external systems, providing insights into application behavior and user interactions. A performance trace may be used to emphasize a performance metric(s) and can include elements from execution, system, and/or event traces in cases in which such traces include metrics relevant to evaluating and improving overall system performance. As such, a performance trace may draw from other traces to gather comprehensive insights into performance characteristics.

Specific examples of performance traces include browser traces and Event Trace Log (ETL). ETL message may be collected by Event Tracing for Windows (ETW). Browser traces, such as Chromium traces, refer to traces obtained via a performance tracing tool built into a web browser (e.g., such as the Chromium web browser). Such browser traces may record detailed performance data of web applications, including rendering performance, JavaScript execution, and network activity. An ETL trace generally refers traces obtained by a tracing framework (e.g., provided by Microsoft) that allows logging of high-frequency events from the Microsoft Windows operating system and applications.

As another example, performance data may be obtained in the form of markers. A marker may refer to a specific, significant point or event within a timeline. A marker may serve as a reference point that indicates when and where certain actions or changes occur. In this way, a set of markers may provide a high-level overview by focusing on key events (e.g., transitions between major stages). For example, a first marker may correspond with a process start time, a second marker may correspond with a time or state at intermediate stage 1, a third marker may correspond with a time or state at intermediate stage 2, and a fourth marker may correspond with a process end time. In this regard, while a trace may include a detailed, sequential record of all events and actions (e.g., logs every function call, execution time, and memory allocation) and logs may capture a comprehensive set of data points over time (e.g., every action taken by the system, user inputs, system outputs, error messages, and the like), markers may highlight only the most significant events in the process.

In some cases, performance data may be obtained by accessing the performance data from a data store, such as data store 214. For instance, performance data, such as traces and log data, may be automatically generated by systems, applications, and/or devices during operation and, thereafter, be stored in a data store. Performance data obtained from a data store 214 may be obtained in association with a particular time frame or in association with a particular performance issue. As one example, assume a source identification request initiated by a user (e.g., a programmer, developer, or manager) indicates to analyze performance data associated with an increase in memory utilization associated with a particular set of code and occurring during a particular time frame (e.g., the last week). In such a case, the performance data obtainer 220 may obtain, from the data store 214, performance data associated with the particular set of code having the increase in memory during the particular time frame may be obtained.

Additionally or alternatively, performance data may be obtained based on a data obtaining request. For instance, performance traces may be obtained based on a specific request to obtain data, for example, for detailed analysis or troubleshooting purposes. In this way, a data obtaining request may be generated to capture traces related to a specific user session(s), transaction failure, performance bottleneck, or other performance issues or data variabilities. By way of example, assume it is recognized that a click event generally occurring over 10 ms is detected or identified as occurring at a longer time period, such as near 30 ms. In such a case, a data obtaining request may be generated that requests (e.g., via a payload) subsequent traces, for instance in association with the greater click event times of 30 ms, to identify various information, such as system(s) and/or application(s) executing, memory, CPU utilization, and/or the like. Additionally, a data obtaining request may be generated that requests subsequent traces in association with click events of 10 ms, for comparison purposes as described herein. In this way, traces may be obtained in association with a normal or base state and in association with an altered or varied state (e.g., that exhibits an issue or problem).

In embodiments, the performance data obtainer 220 may obtain performance data in association with different environments. In this way, the performance data obtainer 220 may obtain performance data in association with a first environment, such as a control dataset, and performance data in association with a second environment, such as a treatment dataset. A control dataset, or cluster, generally refers to performance data that does not correspond to performance variability. Generally, a control data set serves as a baseline or unaltered data to provide a reference point against which the effects of the treatment dataset are compared. A control dataset may include a cluster of traces or logs corresponding with a baseline. A treatment dataset generally refers to performance data that corresponds to performance variability being analyzed. Generally, the treatment dataset is compared with the control dataset to determine effect or impact associated with a treatment, that is, performance variability. The treatment dataset may include a cluster of traces or logs corresponding with performance variability.

Although two environments are generally discussed herein, any number of environments may be used to cluster performance data (e.g., traces). Further, although the control and treatment datasets are generally described as including multiple traces or logs (e.g., 100 traces in the control group and 100 traces in the treatment group), that need not be the case and a single trace may be used. Further, performance data may be obtained in association with any time period or time duration. Such a time period may be a default time period, a user specified time period, a determined time period, or the like.

In addition to collecting or obtaining performance data, in some cases, the performance data obtainer 220 may preprocess the performance data. In this regard, the performance data may be preprocessed such that the data is in a consistent format to facilitate data analysis. As one example, the performance data obtainer 220 may include a data cleaner/normalizer 228 to perform preprocessing operations. For instance, traces may be obtained from multiple data sources or instances of a system or application (e.g., different operating systems, different threads, different process architectures, or the like). As such, the data cleaner/normalizer 228 may normalize the traces by converting timestamps, standardizing event names, and/or cleaning data. As one example, assume different OSes, threads, and/or process architectures are reflected in traces that call a same function(s). In such a case, the data indicating the OS, threads, and/or process architectures may be removed to clean the data such that a comparison can be made across traces. In this way, to normalize the data to compare across traces, various identifiers, such as process identifiers, node identifiers, and/or the like may be removed. In some embodiments, machine learning, such as an LLM, may be used to extract function identifiers or remove other identifiers. For example, an LLM may be used to extract function identifiers and remove process and thread identifiers.

The relevant performance data manager 222 is generally configured to identify relevant performance data to use in identifying performance variability sources. In this regard, the relevant performance data manager 222 identifies performance data that is more targeted, focused, or directed to providing a source of performance data variability.

In embodiments, at a high level, to identify relevant performance data, from obtained performance data, the relevant performance data manager 222 may identify commonalities of performance data within different environments to represent the different environments and, thereafter, identify differences between the performance data in the different environments. By way of example, assume a first set of performance traces corresponds with a control environment and a second set of performance traces corresponds with a treatment environment. In such a case, common traits associated with the first set of performance traces may be identified, and common traits associated with the second set of performances traces may be identified. The common traits associated with the first set of performance traces may then be compared to the common traits associated with the second set of performance traces to identify differences among the different sets of common traits. Such differences may represent or indicate a source of performance variability.

In embodiments, graphs may be used to identify such a source of performance variability. To do so, initially, a performance graph generator 230 may transform the performance data into corresponding performance graphs. A performance graph may be in any number of forms. In one embodiment, a performance graph may be in the form of an edge-node graph that represents the nodes (vertices) and edges within a network or system. In this way, a performance graph facilitates identification of how different components of a system interface and perform, providing various insights related to, for instance, latency, throughput, and resource utilization.

In embodiments, performance graphs may be generated in association with a performance metric(s). A performance metric may refer to an extent or measure used to evaluate the efficiency, effectiveness, and/or overall performance of a system, process, or component. A performance metric may measure any type of performance, such as time and/or memory. In this regard, examples of performance metrics include a time metric(s) and a memory metric(s). As such, performance graphs may be generated in association with a time metric(s) and/or in association with a memory metric(s).

A time metric generally refers to an aspect of time related to the performance of a system, a process, an application, and/or a component. A time metric may be an elapsed time, CPU time, self time, user time, system time, response time, throughput time, latency time, idle time, wait time, execution time, queue time, garbage collection time, context switch time, or the like. Elapsed time, or wall clock time, generally refers to the total time taken from the start to the end of a process or event, as observed in real time (e.g., includes all time regardless of CPU operations). CPU time may refer to the actual time during which a CPU was actively executing a process (e.g., excludes time spent waiting for I/O operations or other processes). Self time, which may also be referred to as exclusive time, may generally refer to an amount of time a specific function or method in a program spends executing its own code, excluding the time spent in any other functions or methods that it calls. User time refers to the time spent by the CPU executing user-level code (e.g., code written by the user). System time refers to the time spent by the CPU executing system-level code (e.g., operating system functions on behalf of the process). Response time refers to the total time spent for a system to respond to a request (e.g., includes time taken to process the request and the time taken for the response to travel back to the requester). Throughput time refers to the amount of time taken to complete a process from start to finish, typically used in the context of workflows and pipelines. Latency time refers to the time delay between a request and the start of its processing. Idle time refers to the time during which a system or component is not actively being used. Wait time refers to time a process spends waiting for resources, such as I/O operations to complete or for a lock to be released. Execution time generally refers to time taken by a program or a function to execute, excluding any time spent waiting for other processes or I/O operations. Queue time generally refers to the time a process spends waiting in a queue before it gets processed. Garbage collection time generally refers to time spent by the garbage collector to reclaim memory. Context switch time generally refers the time taken to switch the CPU from one process or thread to another (e.g., including saving the state of the current process and loading the state of the next process).

A memory metric generally refers to an aspect of memory usage related to the performance of applications and systems. Examples of memory metrics include used memory, free memory, buffered memory, cached memory, resident set size memory, virtual memory size, memory utilization, heap memory, stack memory, and garbage collection memory. Used memory refers to an amount of memory currently being used by a system(s) and/or application(s). Free memory refers to the amount of memory that is not currently in use and is available for allocation. Buffered memory refers to memory used by an operating system to buffer disk reads and writes. Cached memory refers to the memory used by the operating system to cache recently accessed data to improve performance. Resident set size refers to the portion of a process's memory that is held in RAM. Virtual memory size refers to the total amount of memory a process can access, including memory that is swapped out and memory that is allocated but not yet used. Memory utilization refers to the percentage of total memory currently in use. Heap memory refers to the portion of memory used for dynamic memory allocation. Stack memory refers to the portion of memory used for static memory allocation. Garbage collection memory refers to metrics related to the memory management and garbage collection process in managed runtime environments.

To generate a performance graph from performance data, such as a performance trace, the performance data may be transformed into a graphical representation. For example, graphical representation(s) may be generated in which nodes represent events, such as function calls, and edges represent the relationship or transitions between these events or function calls. As described, performance traces or logs may include events, timestamps, and/or additional metrics (e.g., CPU time, elapsed time, or the like). Each unique event or function call in a performance data, such as a trace, may be transformed to a node in the graph. The edges between nodes may be created based on a sequence of events in the trace. In some cases, the direction of an edge may represent the order in which events occurred. The distance of the edge may encode a function of time or memory. For instance, for a time metric, an edge distance may encode a function of the time metric. As another example, for a memory metric, an edge distance may indicate a memory. For instance, assume a first function at a first time corresponds with 30 MB and a second function at a second time corresponds with 31 MB. In such a case, the edge or distance between the nodes associated with the first function and the second function may be 1 MB. Additional metrics may be included as attributes of nodes or edges, such as time metrics and/or memory metrics.

In some cases, a performance graph (e.g., in the form of a node-edge graph) is generated in association with a particular metric. In this way, multiple performance graphs may be generated for various time metrics and memory metrics in association with a particular performance trace or log. For example, the edges of a performance graph may represent a particular time metric. For instance, assume time metrics include CPU time, elapsed time, and self time. In such a case, a first performance graph corresponding with a performance trace may be generated in association with CPU time, a second performance graph corresponding with the performance trace may be generated in association with elapsed time, and a third performance graph corresponding with the performance trace may be generated in association with self time.

As another example, the edges of a performance graph may represent a particular memory metric. For instance, assume memory metrics include memory utilization and used memory. In such a case, a first performance graph corresponding with a performance trace may be generated in association with memory utilization, and a second performance graph corresponding with the performance trace may be generated in association with used memory.

As described, in some cases, performance graphs corresponding with a particular performance trace or log may be generated for various metrics, such as time and/or memory metrics. For example, a predetermined set of metrics may be used to generate performance graphs. As another example, a particular metric(s) may be determined to use to generate performance graphs. For instance, in cases in which a memory issue is recognized, only performance graphs corresponding with memory metrics may be generated. Even more particularly, if a particular type of memory metric is recognized or identified, only performance graphs corresponding with the particular type of memory metric may be generated.

Although a performance graph corresponding with a particular performance trace or log may be generated in association with a particular metric, in some embodiments, a performance graph may reflect multiple metrics. In this regard, the sequential data from a performance trace may be transformed into a graphical representation in which nodes represent events or states, and edges represent the transitions between these nodes, annotated with multiple metrics. In this regard, each edge may be associated with multiple metrics derived from the performance data. Such metrics may include, for example, elapsed time between events, CPU time consumed, memory usage change, or any other relevant performance metric.

The particular metric(s) to use for generating corresponding performance graphs may be determined in any number of ways. For example, in some cases, performance graphs may be generated for each metric indicated or that may be derived from performance data (e.g., traces). In other cases, the particular metric(s) may be predetermined or specified. For instance, a particular predetermined set of metrics may be used for generating performance graphs. In yet other cases, a particular metric(s) may be determined based on a user input.

In accordance with generating performance graphs in association with various performance data (e.g., performance traces), a common graph generator 232 may be configured to generate common graphs. A common graph generally refers to a graph (e.g., an edge-node graph) that includes common traits shared across performance graphs. Common traits generally refer to shared events, features, patterns, or behaviors across multiple graphs. Such common traits highlight what is consistent or recurring in the datasets, thereby providing insights into stable or expected behaviors. By way of example, assume 100 traces having various functions are analyzed. In such a case, common graph is generated that includes the set of functions commonly used among the traces. In this regard, a common graph may be generated that excludes or removes nodes that are not deemed common among analyzed performance data, such as performance traces. In embodiments, the common graph generator 232 generates a common graph for performance data associated with a treatment environment and a common graph for performance data associated with a control environment. In this regard, a first common graph or structure that represents common traits associated with a control performance dataset is generated, and a second common graph or structure that represents common traits associated with a treatment performance dataset is generated.

In some embodiments, common traits include functions that have a highest occurrence across performance data, such as performance traces. In one example, identifying common traits may be performed using a counter-based approach. For example, assume among 100 traces, function A was called in one trace and function E was called in one trace. A count of one for function A and function E would unlikely be identified as a common trait. Any threshold value may be used to identify common traits. For instance, in some cases, functions called in more than 80% of traces analyzed may be identified as common functions. As another example, a particular number of most common traces may be identified as common traits. For instance, assume 1,000 traces are analyzed. The top 500 most common traces may be identified and deemed common across the traces.

In generating a common graph, the edges or metrics (e.g. time metric(s) or memory metric(s)) may be represented in any number of ways. In some cases, an average, a median, a standard deviation, or a combination thereof (or other statistic or measure) may be used to represent the different metrics across the individual performance graphs. By way of example only, assume a first node represents function A and a second node represents function B, both of which were identified as common traits among a set of performance graphs. Further assume that in a first performance graph, the distance or time metric between function A and function B is 10 ms, and in a second performance graph, the distance or time metric between function A and function B is 12 ms. In generating a common graph, the edge between function A and function B may be represented as 11 ms. The raw data (e.g., metrics) may be stored or may be discarded.

As described, and similar to the performance graphs, the common graphs may correspond with a particular metric. As such, in cases in which generating multiple performance graphs for different metrics, multiple common graphs may be generated. For example, assume performance graphs are generated for a first metric (e.g., a time metric) and a second metric (e.g., a memory metric). In this way, for a first cluster of performance graphs associated with the first metric, a first common graph is generated, for a second cluster of performance graphs associated with the second metric, a second common graph is generated, and so on.

In embodiments, such common graphs are generated for clusters of performance graphs for both the treatment datasets and control datasets. For instance, for a particular time metric, assume a first set of performance graphs is generated in association with a control dataset, and a second set of performance graphs is generated in association with a treatment dataset. In such a case, a first common graph associated with the particular time metric may be generated to represent the first set of performance graphs in association with the control dataset, and a second common graph associated with the particular time metric may be generated to represent the second set of performance graphs in association with the treatment dataset.

In accordance with generating common graphs, the differential graph generator 234 may generate differential graphs. A differential graph generally refers to a graph used to compare two datasets by representing differences and/or commonalities between them. In this way, a differential graph may emphasize variations between two datasets. In some cases, a differential graph may also identify elements or aspects that are present in both graphs or datasets. At a high level, to generate a differential graph associated with a metric(s), such as a time metric, a common graph generated for one environment (e.g., control environment) may be combined or aggregated with a common graph generated for another environment (e.g., treatment environment).

More particularly, common graphs associated with a metric may be merged to create a unified dataset that includes nodes from both the control and treatment environments. The combined dataset may serve as a basis for identifying differences and similarities among the data. For example, the combined dataset may be analyzed to determine which nodes (e.g. functions) are present in both environments. In this way, nodes that appear in both the control and treatment environment, nodes that appear in only the control environment (e.g., exclusive to the control group), and nodes that appear in only the treatment environment (e.g., exclusive to the treatment group) may be identified.

Differences among the common graphs may be identified. For example, for nodes present in both environments, differences in corresponding metrics may be identified (e.g., time differences, occurrence counts, or the like). In this way, positive and negative differences reflecting changes or differences in metrics between control and treatment environments may be determined.

The differences may then be used to construct a differential graph including nodes representing events, such as functions or function calls, and edges representing relationships or transitions between the nodes, such as distances representing time or memory metrics. In embodiments, edges may represent changes or differences between environments or datasets. Stated differently, an edge may represent magnitude or significance of differences. For instance, an edge between a first node and a second node may represent a difference in a time metric or memory metric associated with the first and second nodes in the common graphs. By way of example, assume a first common graph of a first environment includes an edge representing 10 ms between a first node and a second node, and a second common graph of a second environment includes an edge representing 15 ms between the first node and the second node. In such a case, the differential graph may include an edge representing the difference of 5 ms between the first node and the second node. Edges may reflect differences in any type of metric, such as time differences (e.g., how much earlier or later certain events occur in treatment versus control), resource usage (e.g., differences in memory usage), and/or the like. In other implementations, edges may represent both of the metrics associated with the common graphs, as opposed to differences therebetween.

In some cases, nodes may be distinguished (e.g., color coded) based on their presence in the control environment only, presence in the treatment environment only, and presence in both environments. In some cases, nodes exclusive to one environment may appear disconnected from nodes in another environment, while edges indicate differences in metrics between common nodes.

As can be appreciated, in some cases, a differential graph corresponds with a particular metric. For example, a first differential graph may correspond with a first metric, and a second differential graph may correspond with a second metric.

In some embodiments, structural graphs may be generated. In this way, a structural graph generator 236 may be configured to generate structural graphs. Structural graphs may be generated to supplement or complement other graphs generated by the relevant performance data manager 222, such as differential graphs generated by the differential graph generator 234. In this regard, structural graphs may also be generated along with differential graphs associated with time metrics and/or differential graphs associated with memory metrics. A structural graph may model flow of information, resources, or the like. Nodes may represent events, such as processes, functions, tasks, components, or the like. Edges may represent the flow of movement between the nodes. Such a flow representation indicates transfer of resources or information within a system. In embodiments, the structural graphs represent inflows and/or outflows of connections between nodes. For example, assume a structural graph includes a first node that represents a function A and a second node that represents function B. In such a case, the structural graph may represent how many calls function A makes to function B and how many calls function B makes to function A.

To generate a structural graph, the structural graph generator 236 may use performance data obtained by performance data obtainer 220. For example, the structural graph generator 236 may generate a structural graph using a performance trace. As such, structural graphs may be generated for corresponding performance traces or logs. In some cases, structural graphs are generated for corresponding environments. In this way, performance data, such as traces, associated with a control environment may be used to generate various structural graphs for the control environment, and performance data, such as traces, associated with a treatment environment may be used to generate various structural graphs for the treatment environment.

The relevant performance data identifier 238 may be configured to identify relevant performance data for use in identifying a source(s) of data variability. In embodiments, the relevant performance data identifier 238 may identify the differential graph(s) and/or structural graph(s), or portions thereof, as relevant performance data for use in identifying a source(s) of data variability. Using differential graphs reduces the performance data to relevant performance data that may be used to identify a source(s) of data variability. As one example, a differential graph associated with a time metric may be identified as relevant performance data. In another example, a portion of a differential graph associated with a time metric may be identified as relevant performance data. For instance, differences greater than a threshold value may be identified as relevant performance data. Although differential graphs, or portions thereof, are generally identified as relevant performance data, other graphs or data may be additionally or alternatively identified (e.g., performance graphs, common graphs, or the like).

In embodiments, the relevant performance data identifier 238 may convert or transform data in the form of graphs into a format that may be more suited for a data analysis component to identify a source(s) of data variability. For example, differential graphs may be transformed into a representation or format understandable, for example, by an LLM. By way of example only, the relevant performance data identifier 238 may transform a differential graph, or portion thereof, to a matrix representation. A matric representation may include, for example, representations of node functions, numbers or counts in control environment, numbers or counts in treatment environment. For instance, for a differential graph associated with a time metric, a matrix may be generated that includes functions represented by nodes in the differential graph. In addition, in association with the functions, the matrix may include times associated with the control environment and times associated with the treatment environment.

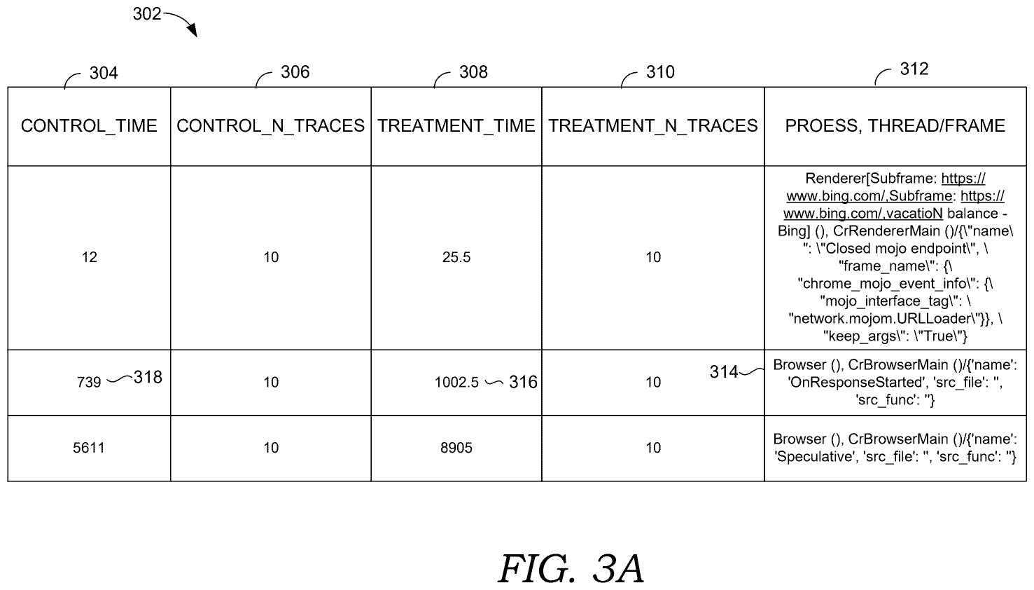

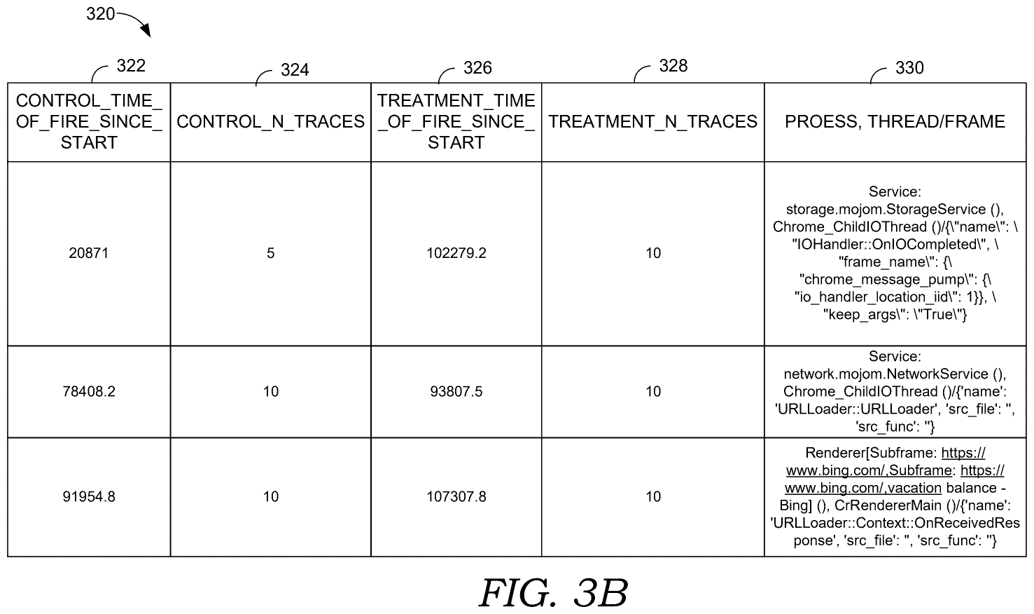

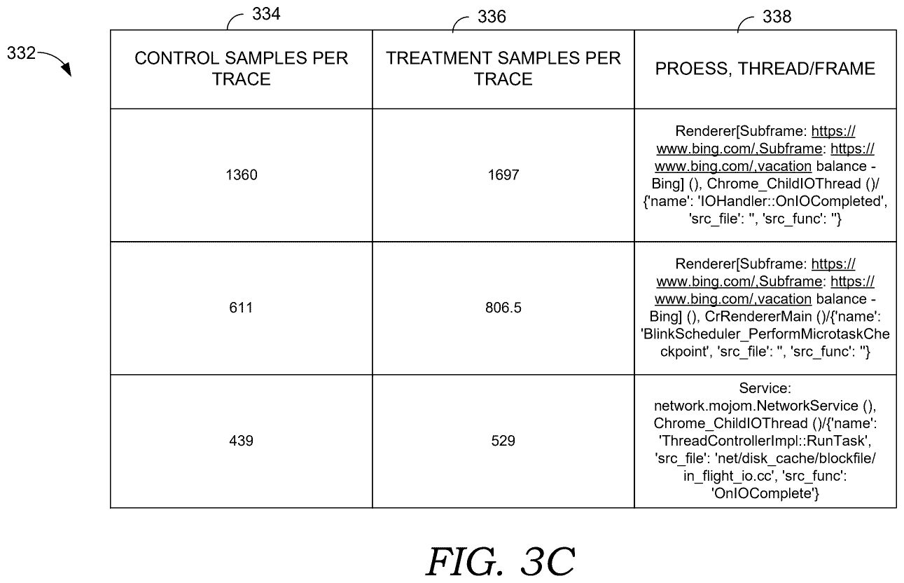

By way of example only, FIGS. 3A-3C provide example matrices representing various differential graphs. With initial reference to FIG. 3A, FIG. 3A represents a matrix 302 corresponding with a differential graph corresponding with a time metric. Matrix 302 includes a first column 304 for time (e.g., in milliseconds) associated with a control environment, a second column 306 for a number of traces associated with the control environment, a third column 308 for time (e.g., in milliseconds) associated with the treatment environment, a fourth column 310 for a number of traces associated with the treatment environment, and a fifth column 312 for a process and thread/frame. In this way, for each process and thread/frame, a metric(s) may be provided, such as a time metric. For example, for the process and thread/frame 314, the process is the ‘Browser ( )’ that refers to the browser application as a whole. The thread is the ‘CRBrowserMain ( )’ that refers to the main thread within the browser process. The frame is the ‘{‘name’: ‘OnResponseStarted’, ‘src_file’: “, ‘src_func’:” }’ that refers to the specific function call (stack frame) being executed within the thread. For the particular process and thread/frame 314, the corresponding treatment time 316 is 1002.5 and the corresponding control time 318 is 739.

Turning to FIG. 3B, FIG. 3B represents a matrix 320 corresponding with a differential graph corresponding with a time metric. Matrix 320 includes a first column 322 for time of fire since start (e.g., in milliseconds) associated with a control environment, a second column 324 for a number of traces associated with the control environment, a third column 326 for time of fire since start (e.g., in milliseconds) associated with the treatment environment, a fourth column 328 for a number of traces associated with the treatment environment, and a fifth column 330 for a process and thread/frame. In this way, for each process and thread/frame, a metric(s) may be provided, such as a time metric. A time of fire since start metric generally refers to the elapsed time from the start of a process, task, or event until a specific action or event (referred to as “fire”) occurs.

With reference to FIG. 3C, FIG. 3C represents a matrix 330 corresponding with a differential graph corresponding with a samples per trace metric. Matrix 330 includes a first column 332 for a number of samples per trace associated with a control environment, a second column 334 for a number of samples per trace associated with a treatment environment, and a third column 336 for a process and thread/frame. In this way, for each process and thread/frame, a metric(s) may be provided, such as a samples per trace metric.

The relevant performance data identifier 238 may additionally or alternatively transform the structural graph into a format suitable for use in identifying a source(s) of data variability. In embodiments, the relevant performance data identifier 238 may analyze structural graphs to identify relevant performance data for use in identifying a source(s) of data variability. In this regard, in one embodiment, the relevant performance data identifier 238 may transform structural graphs into matrices. For example, a matrix representation for a structural graph may include each node (e.g., representing an event or function), which may be labeled (e.g., L1, L2, and the like). For each particular node in the structural graph, the number of other nodes the particular node calls and the number of other nodes that call the particular node may be recorded, for instance, as inflows and outflows. A matrix may then be constructed with each entry indicating a presence or absence of a connection between the nodes. In this regard, the matrix may capture the structure, including how many nodes exist, how many inflows, and how many outflows. The matrix may generally captures the structure of the graph without considering distances or time.

In some cases, the matrix representing a structural graph is converted into a vector format, or set of vectors that encapsulate the structural information of the graph. In some cases, a separate vector may be generated in association with each node, thereby resulting in a set of vectors to represent the structural graph. The vectors may then be mapped into a vector space or latent space. Using such a vector or latent space enables the comparison of different graphs by measuring distances between the vectors. In such a case, vector V1 may be mapped into space to represent a first node associated with a structural graph, vector V2 may be mapped into space to represent a second node of the structural graph, and so on. The vectors associated with a structural graph may then be compared to other vectors associated with one or more other structural graphs to identify or compute distances therebetween. In cases in which the distances are small, or below a threshold value, the nodes may be identified as structurally similar. In cases in which the distances are large, or above a threshold value, the nodes may be identified as structurally dissimilar.

In particular, distances between vectors in the latent space may be determined. Small distances may indicate structure similarity between nodes of different graphs. As such, vectors from different graphs may be compared to determine structural similarities and differences. Distances may be determined in any of a number of ways. In one embodiment, to determine distances, a cross-product calculation is used. For instance, for each pair of corresponding nodes from two graphs, a Euclidean distance may be determined between their vectors. For more than two graphs, the formula may be extended to account for the additional graphs. The determined distances between vectors generally provides a high-level understanding of the structural similarities and differences across multiple graphs. As such, nodes that are structurally similar or different may be identified to facilitate determining aspects to further analyze based on their structural properties. In some cases, prior to determining distances in association with particular nodes, an overall structure may be analyzed. For instance, in cases in which structures as a whole do not align, further analysis of the nodes may not be performed.

In embodiments, the vectors and corresponding distances in latent space may be used as relevant performance data to use in identifying a source(s) of performance data variability. For example, the vectors and/or corresponding distances may be used to annotate other identified relevant performance data, such as differential graphs or other representations thereof (e.g., matrices).

By way of example, and with reference to FIG. 2B, FIG. 2B provides an example data transformation process. In FIG. 2B, graph model 272 may be generated in association with a first environment 270, and graph model 280 may be generated in association with a second environment 278. The graph models 272 and 280 may be transformed into a format suitable for use in identifying a source(s) of data variability. In this regard, a relabeling and data cleaning process 274 and 282 may occur in association with graph model 272 and graph model 280, respectively. The relabeled and clean data may be transformed into corresponding sets of labels, or normalized matrix, in association with nodes. For example, the graph model 272 may be cleaned and transformed into a set of labels 276, and the graph model 280 may be cleaned and transformed into a set of labels 284. Such sets of labels, or normalized matrix, may then be converted into a vector format, as shown at 286, that represent the graphs. The vectors may then be mapped into a vector space or latent space 288. Using such a vector or latent space enables the comparison of different graphs by measuring distances between the vectors.

Returning to FIG. 2A, the source identification manager 224 is generally configured to facilitate identification of a source(s) in association with performance data variability. To identify a source(s) associated with performance data variability, the source identification manager 224 may include or use artificial intelligence (AI), machine learning, or any other technology to analyze the identified relevant performance data. For example, the source identification manager 224 may use AI to determine a source associated with performance data variability based on a differential graph(s) or a representation(s) thereof (e.g., a matrix corresponding with the differential graph).

In one embodiment, the source identification manager 224 may include a prompt generator 240 and an AI agent 242 to identify a source(s) associated with performance data variability. At a high level, the prompt generator 240 may be configured to generate a prompt that is used as input to an AI agent 242 to provide a response indicating or identifying a source(s) associated with performance data variability.

The prompt generator 240 is generally configured to generate a prompt that is used, as input, to an AI agent. A prompt, or input prompt, generally refers to a request for data from which an AI response may be generated. In this regard, a prompt may be used to retrieve relevant information, perform specific tasks, or provide accurate responses based on the input prompt. In some cases, a prompt is generated by the prompt generator 240 based on a user's input or request. In this way, a request or query input by a user may provide a basis for formulating an instruction of a prompt. In this way, the prompt generator 240 may use the source identification request 252 of the input data to derive an instruction for the prompt. For example, the prompt generator 240 may take as input the request and perform additional processing or refinement of the request to convert the request or generate a prompt in a format that is suitable for the specific task or information retrieval. The instruction seeking desired information may be provided in any level of granularity. In some cases, an instruction may be a general instruction requesting identification of a source(s) associated with performance variability, identification of changes, a summarization of changes or variability, or an explanation of the information provided. In other cases, an instruction may be specific to a problem (e.g., based on a request or input provided by a user). For instance, a user may specify a desired to understand an underlying cause of a 100 ms delay in creating fonts.

To generate a prompt that is suitable to generate a desired AI response, the prompt manager 240 may use relevant performance data, for example, identified via relevant performance data manager 222. For example, in one embodiment, relevant performance data in the form of differential graphs or matrices associated therewith may be used to generate a prompt. In this way, a differential graph(s) and/or corresponding matrix(s) may be included or referenced in a prompt for use in identifying a source related to performance variability. As described, in some cases, a matrix may correspond with a particular metric. For instance, a matrix may be generated from a differential graph in association with elapsed time. In such a case, the matrix may reflect the various nodes and corresponding elapsed times. Elapsed time may be reflected or represented using various statistics in the matrix, such as mean, median, count, or the like. In other cases, a matrix may be generated that represents various metrics. For example, a matrix may be generated that represents multiple differential graphs associated with different metrics (e.g., elapsed time, memory, CPU time, wall clock time, or the like).

In some cases, a prompt may additionally include descriptions for various aspects of the differential graph and/or matrix. For example, a matrix representing a differential graph may include various columns with statistical and/or structural information in association with various functions. As such, in addition to providing a matrix, a description of each column may be provided. For instance, a first column may represent functions, a second column may represent a mean time, a third column may represent a media time, and a fourth column may represent an indication of structural features associated with the corresponding function. In this example, structural data is used to further annotate nodes in the matrix representing the differential graph.

Further, in some embodiments, a prompt may be generated to include structural data (e.g., separate from the differential graph). Such structural data may be in the form of a structural graph or set of structural graphs. In other cases, the structural data may be such data derived from analysis of the structural graphs. For instance, as described in relation to the relevant performance data identifier 238, structural graphs may be transformed into a format suitable for use in identifying a source(s) of data variability. In this way, the structural graphs may be used to identify differences and/or similarities among structures, for instance, using distances in latent space between nodes. Such structural data may be represented (e.g., within a matrix or separate from matrix) in any of a number of ways. As one example, structural data may indicates nodes that are structurally similar to one another or nodes that are structurally dissimilar to one another. As another example, structural data may represent a percentage or ranking associated with a function. For example, assume function A corresponds with a ranking of 50 in association with a first environment and a ranking of 1 in association with a second environment. In such a case, these rankings indicate the function A was called in both environments, but called more frequently in one environment than the other environment.

As can be appreciated, the prompt generator 240 may generate various prompts. For example, assume a first matrix corresponds with a first metric, a second matrix corresponds with a second metric, and a third matrix corresponds with a third metric. In such a case, a first prompt may be generated that includes the first matrix and requests identification of a source of performance data variability in association therewith, a second prompt may be generated that includes the second matrix and requests identification of a source of performance data variability in association therewith, and a third prompt may be generated that includes the third matrix and requests identification of a source of performance data variability in association therewith. Further, in some cases, in accordance with obtaining responses for each of the first prompt, the second prompt, and the third prompt, the prompt generator 240 may generate a summary prompt that requests a summarization of the responses generated in accordance with the first prompt, the second prompt, and the third prompt. For instance, assume a first response provides an indication of a source of performance data variability in association with elapsed time, a second response provides an indication of a source of performance data variability in association with a CPU time, and a third response provides an indication of a source of performance data variability in association with memory. In such a case, a summary prompt may be generated to request a summary of the first, second, and third response related to elapsed time, CPU time, and memory. In other cases, the prompt generator 240 may provide each of the matrices in a single prompt and also request summarization of the different evaluations of the data.

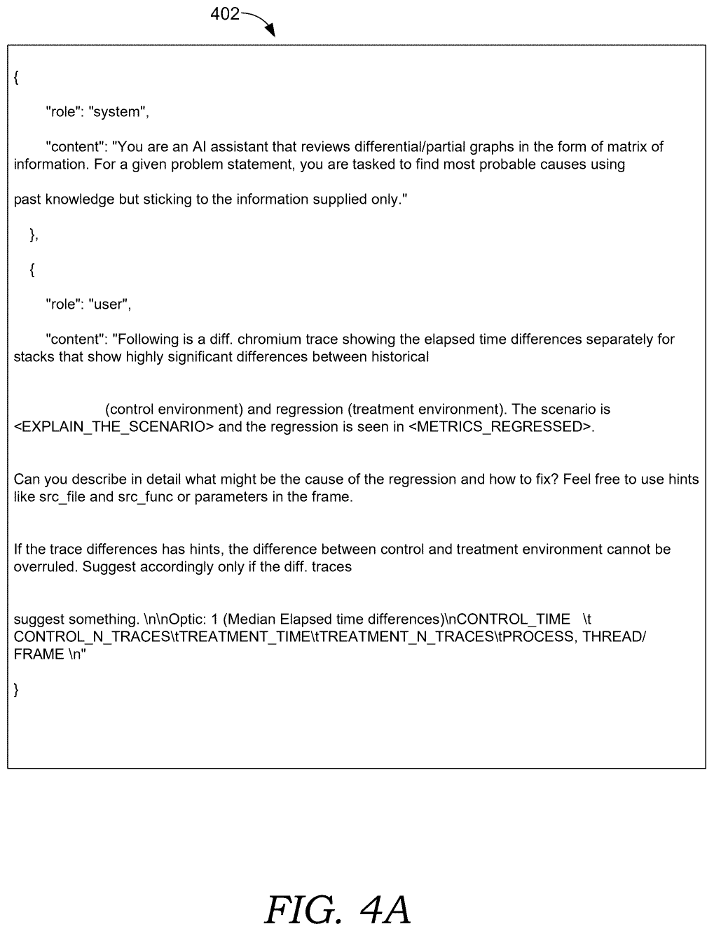

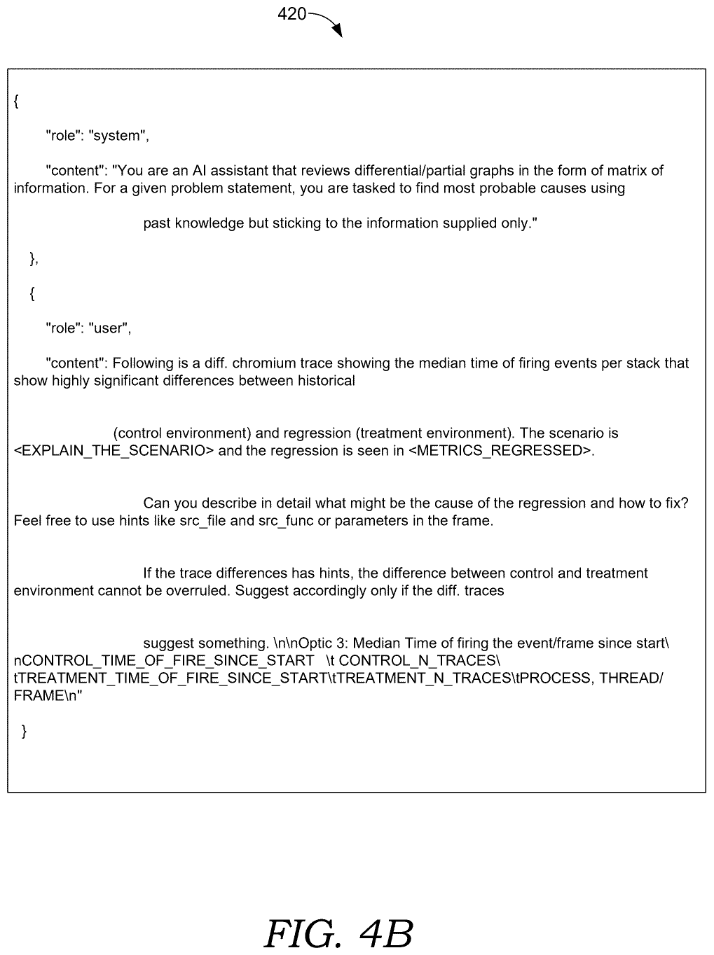

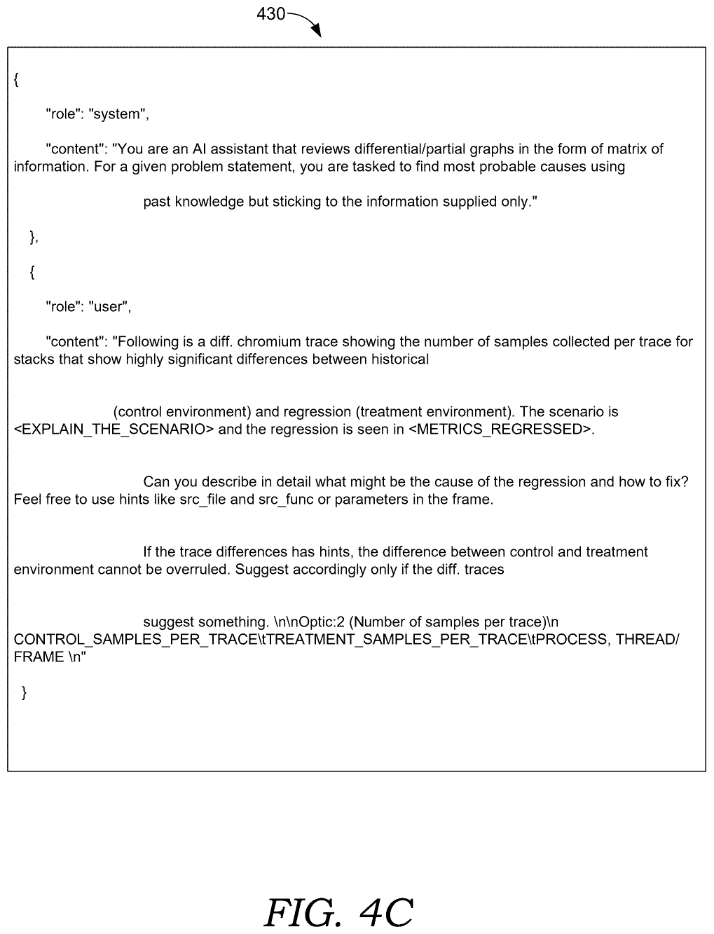

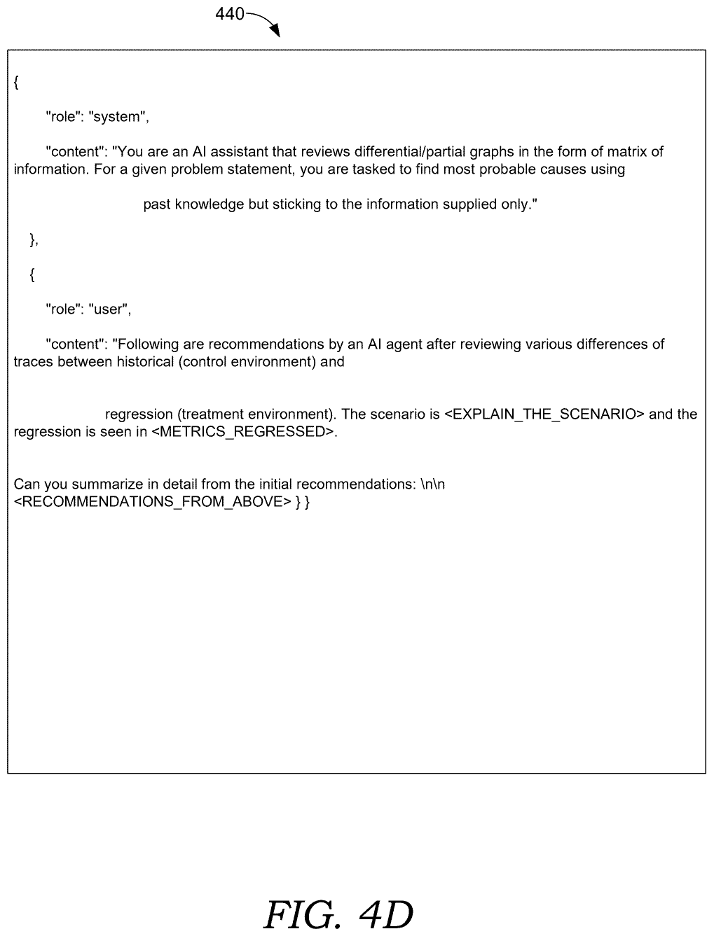

The prompt generator 240 may provide generated prompts to the AI agent 242 to initiate execution of the prompts. In this way, the prompt generator 240 may communicate the generated prompt to AI agent 242 to generate a response thereto. FIGS. 4A-4D provide example prompts that may be generated and provided to obtain an AI response. These example prompts are provided for illustrative purposes and are not intended to be limiting to aspects of the technology described herein. With initial reference to FIG. 4A, an example prompt 402 is provided that may include or reference the matrix 302 of FIG. 3A. FIG. 4B provides an example prompt 420 that may include or reference the matrix 320 of FIG. 3B. FIG. 4C provides an example prompt 430 that may include or reference the matrix 330 of FIG. 3C. Assuming each of the prompts 402, 420, and 430 result in an AI response, FIG. 4D provides an example prompt 440 requesting a summary of the AI responses generated in association with prompts 402, 420, and 430.

Returning to FIG. 2A, the AI agent 242 is generally configured to facilitate generation of an AI response. An AI response generally refers to a response generated using AI. In this regard, the AI agent 242 may use or access AI technology to facilitate generation of a response to an input prompt. In particular, the prompt may be used by an AI model, such as an LLM, to generate a response to be provided to a user. A response may be in any form. In some cases, the form of a response may depend on a particular desired format included in a prompt. For example, a prompt may request a response in a table format, a paragraph format, a bullet point format, or the like.

The AI agent 242 may use any type of data to generate an AI response. For example, a representation of relevant performance data (e.g., a matrix representing a differential graph) may be used along with various structural data to generate an AI response. In one embodiment, the AI agent 242 may compile search results into a user-friendly response. For instance, an AI response may be generated that includes a summary of a source(s) identified as contributing to a performance data variability or problem and relevant links in a formatted manner.

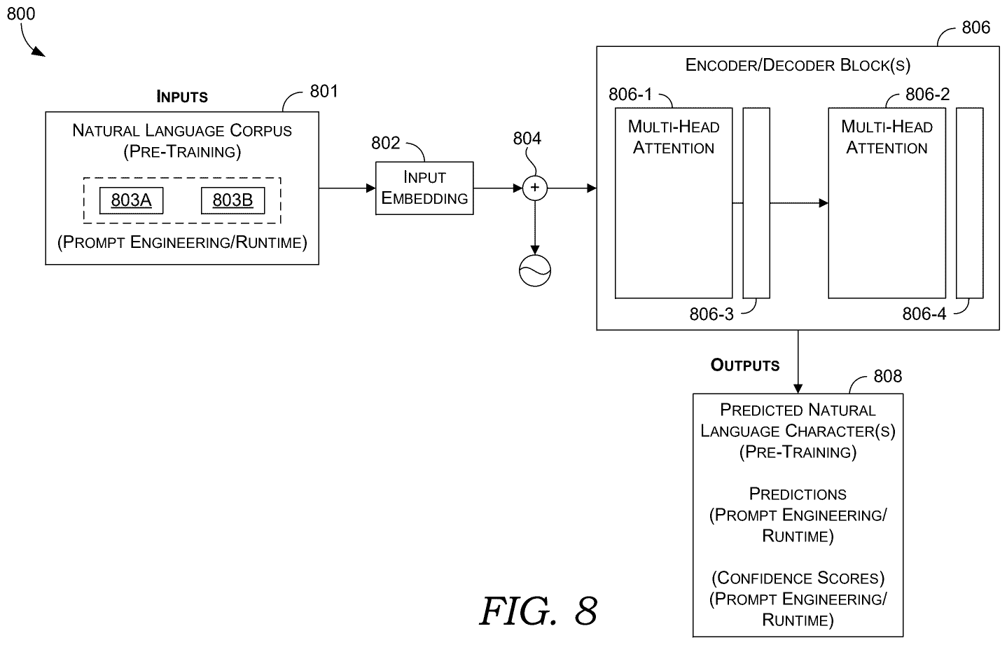

In embodiments, the AI agent 242 may be, include, or access any number of artificial intelligence models or technologies. In some cases, a machine learning model in the form of an LLM is used to generate an AI response. A language model is a statistical and probabilistic tool that determines the probability of a given sequence of words occurring in a sentence (e.g., via next sentence prediction [NSP] or masked language model [MLM]). Simply put, it is a tool that is trained to predict the next word in a sentence. A language model is called a large language model when it is trained on an enormous amount of data. In particular, an LLM refers to a language model including a neural network with an extensive amount of parameters that is trained on an extensive quantity of unlabeled text using self-supervising learning. Oftentimes, LLMs have a parameter count in the billions, or higher. Some examples of LLMs are GOOGLE's BERT and OpenAI's GPT-2, GPT-3, and GPT-4. For instance, GPT-3 is a large language model with 175 billion parameters trained on 570 gigabytes of text. These models have capabilities ranging from writing a simple essay to generating complex computer codes-all with limited to no supervision. Accordingly, an LLM is a deep neural network that is very large (billions to hundreds of billions of parameters) and understands, processes, and produces human natural language by being trained on massive amounts of text. Although some examples provided herein include a single-mode generative model, other models, such as multimodal generative models, are contemplated within the scope of embodiments described herein. Generally, multimodal models are generated to make predictions based on different types of modalities (e.g., text and images). In some embodiments, the AI agent 242 takes on the form of or uses an LLM, but various other artificial intelligence models or technologies can additionally or alternatively be used. One example of an LLM is provided below in reference to FIG. 8. Other models or technology may be used herein, including, but not limited to small language models.

The data provider 226 is generally configured to provide data, such as AI response data 260. In this regard, the data provider 226 may provide AI response data to the user device that provided the source identification request 252 to the performance variability manager 212. In this way, the data provider 226 provides data to be presented that is relevant to source identification request 252. In particular, the user may be presented with an indication of a source of performance data variability. The data provider 226 may provide the AI response to the user device via an appropriate interface (e.g., a chat window, search results page, or the like).

In some cases, the data provider 226 may also provide identified relevant performance data. In this way, in addition to presenting a response to the prompt generated, the user may also view identified relevant performance data used to generate a response. The relevant performance data may be any type of data that is used or generated in the process of generating an AI response. Various types of relevant performance data that may be provided include common graphs, performance graphs, differential graphs, matrix representations of graphs, structural graphs, structural data, and/or the like.

In some cases, the provided data, such as indications of a source(s) associated with performance data variability, may be provided for display. For example, an AI response may indicate a portion of events or a structure (e.g., process, task, machine, function) that may be a potential source associated with a performance data variability, such as an increase in processing times. For instance, an AI response may indicate that function A is called many times and may correspond with a particular regression, decline, or deterioration in progress or performance. Such data may be presented in any number of ways and formats.

In addition or in the alternative to providing AI response data for presentation at a user device, the data provider 226 may provide such data to another system, component, or machine for further analysis. For example, an indication of a source associated with performance data variability may be provided to another data analysis system that further analyzes the data. In some cases, the identified source or issue may be automatically corrected or fixed. For example, assume a particular function is identified as causing an issue. In such a case, the particular function may be automatically corrected to overcome the identified issue.

As discussed, various implementations and combinations of technologies may be used to implement various aspects related to identifying sources of performance data variability. In some cases, the particular technologies employed may depend on the application utilizing such technologies.

### Exemplary Implementations for Identifying Sources of Performance Variability Using Relevant Performance Data

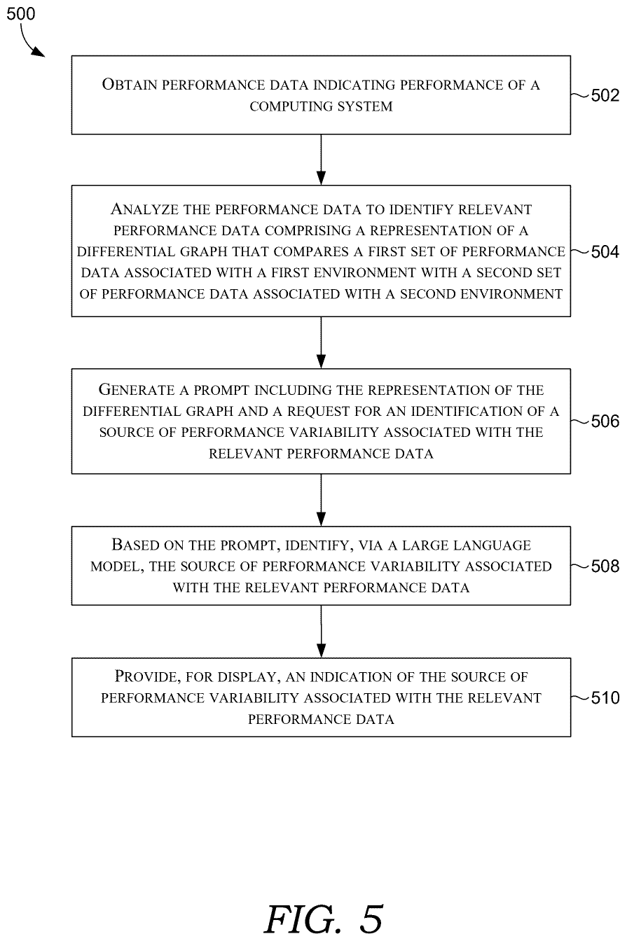

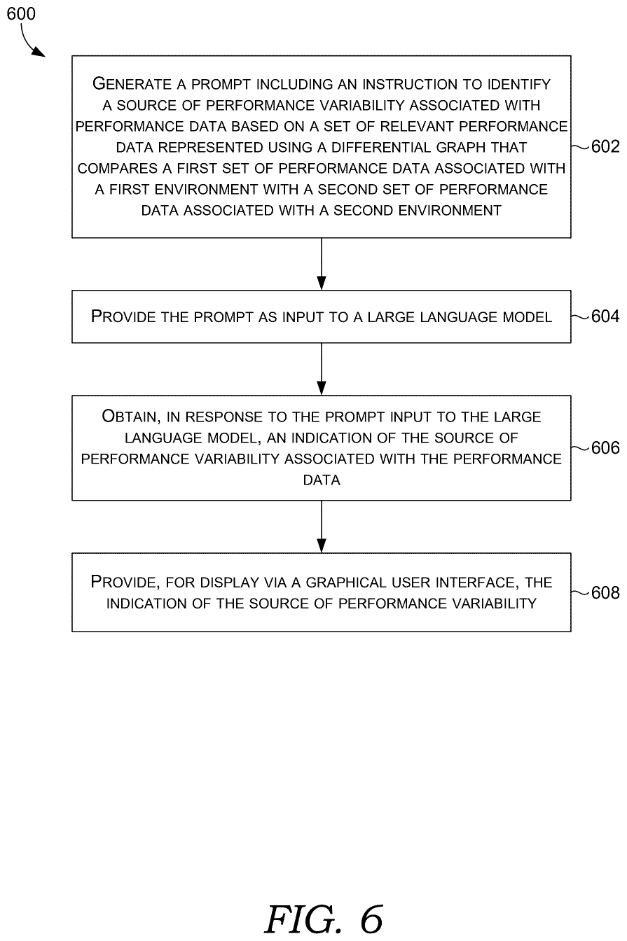

As described, various implementations can be used in accordance with embodiments described herein. FIGS. 5-6 provide methods of identifying sources of performance variability using relevant performance data, in accordance with embodiments described herein. The methods 500 and 600 can be performed by a computer device, such as device 700 described below. The flow diagrams represented in FIGS. 5-6 are intended to be exemplary in nature and not limiting. For example, flow diagrams represented in FIGS. 5-6 represent various combinations of technologies and approaches used to manage identifying sources of performance variability using relevant performance data, but are not intended to reflect all combinations of technologies and approaches that may be used in accordance with embodiments described herein.

With respect to FIG. 5, FIG. 5 provides an example method flow 500 for identifying sources of performance variability using relevant performance data, in accordance with embodiments described herein. At block 502, performance data indicating performance of a computing system is obtained. For example, performance data may indicate performance of a computing device, an application, a network, or a combination thereof. In embodiments, performance data may be in any number of formats, including traces, logs, and/or markers. Performance data in association with one environment (e.g., a control environment) and performance data in association with another environment (e.g., a treatment environment) may be obtained. For example, one set of performance data may correspond with a performance issue (e.g., increase in memory utilization), and the other set of performance data may not corresponding with the performance issue.

At block, 504, the performance data is analyzed to identify relevant performance data comprising a representation of a differential graph that compares a first set of performance data associated with a first environment with a second set of performance data associated with a second environment. In one embodiment, identifying relevant performance data may include generating a first set of performance graphs using a first set of the performance data corresponding with the first environment and a second set of performance graphs using a second set of the performance data corresponding with the second environment. For the first set of performance graphs corresponding with the first environment, a first common graph may be generated including a first set of common traits. For the second set of performance graphs corresponding with the second environment, a second common graph may be generated including the second set of common traits. The first common graph and the second common graph may then be compared to generate the differential graph. Such a differential graph may then be transformed into a matrix for use in the prompt.

At block 506, a prompt is generated that includes the representation of the differential graph and a request for an identification of a source of performance variability associated with the relevant performance data. The representation of the differential graph may be in the form of a matrix including an indication of one or more metrics (e.g., time and/or memory). In embodiments, the prompt may also include data associated with a structural graph(s) generated in association with the performance data.

At block 508, based on the prompt, the source of performance variability associated with the relevant performance data is identified, via a large language model. The source of performance variability may be, for example, a function(s), a process(es), a thread(s), and/or a code portion(s) that corresponds with a potential root cause for a performance issue.

At block 510, an indication of the source of performance variability associated with the relevant performance data is provided for display. In this way, a user, such as a programmer, manager, or developer may recognize the source of a performance issue and evaluate or analyze accordingly. In some cases, alternatively or additionally, the indication of the source of performance variability may be provided to another computing component for further analysis and/or to rectify or resolve the performance issue automatically.

Turning to FIG. 6, FIG. 6 provides an example method flow 600 for identifying a source(s) of performance variability using relevant performance data, in accordance with embodiments described herein. Initially, at block 602, a prompt is generated that includes an instruction to identify a source of performance variability associated with performance data based on a set of relevant performance data represented using a differential graph. The differential graph may compare a first set of performance data associated with a first environment with a second set of performance data associated with a second environment. In embodiments, the first set of performance data comprises a first common graph including common traits among performance graphs associated with the first environment, and the second set of performance data comprises a second common graph including common traits among performance graphs associated with the second environment. In some cases, the prompt may further include structural data identified via structural graphs generated in association with performance data.

At block 604, the prompt is provided as input into a large language model. Thereafter, at block 606, in response to the prompt input to the large language model, an indication of the source of performance variability associated with the performance data is obtained. In some cases, the source of performance variability includes a portion of code, a function, a process, a method, a thread, or a combination thereof.

At block 608, the indication of the source of performance variability is provided for display via a graphical user interface. In this way, a user (e.g., that initiated a request to view the source of performance variability) is provided a particular aspect to further review or analyze in association with a performance issue.

Accordingly, various aspects of technology are directed to systems, methods, and graphical user interfaces for intelligently identifying a source(s) of performance variability using relevant performance data. It is understood that various features, subcombinations, and modifications of the embodiments described herein are of utility and may be employed in other embodiments without reference to other features or subcombinations. Moreover, the order and sequences of steps shown in the example methods 500 and 600 are not meant to limit the scope of the present disclosure in any way, and in fact, the steps may occur in a variety of different sequences within embodiments hereof. Such variations and combinations thereof are also contemplated to be within the scope of embodiments of this disclosure.

In some embodiments, a computing system is provided. The computing system can include a processor and computer storage memory having computer-executable instructions stored thereon that, when executed by the processor, configure the computing system to perform operations. In embodiments, the operations include obtaining performance data indicating performance of a computing system. The operations further include analyzing the performance data to identify relevant performance data comprising a representation of a differential graph that compares a first set of performance data associated with a first environment with a second set of performance data associated with a second environment. The operations further generating a prompt including the representation of the differential graph and a request for an identification of a source of performance variability associated with the relevant performance data. The operations further include providing, for display, an indication of the source of performance variability associated with the relevant performance data. Advantageously, identifying and using the relevant performance data provides a more efficient and effective identification of a source of performance variability, thereby reducing computer resource utilization.

In any combination of the above embodiments of the computing system, the computing system comprises an application, a computing device, a network, or a combination thereof.

In any combination of the above embodiments of the computing system, the performance data comprises traces, logs, and/or markers.

In any combination of the above embodiments of the computing system, analyzing the performance data to identify the relevant performance data comprises generating a first set of performance graphs using a first set of performance data corresponding with the first environment and a second set of performance graphs using a second set of performance data corresponding with the second environment; generating a first common graph that includes a first set of common traits associated with the first set of performance graphs corresponding with the first environment and a second common graph that includes a second set of common traits associated with the second set of performance graphs corresponding with the second environment; and comparing the first common graph corresponding with the first environment with the second common graph corresponding with the second environment to generate the differential graph.

In any combination of the above embodiments of the computing system, the method further includes generating a set of structural graphs and including data associated with the structural graphs in the prompt.

In any combination of the above embodiments of the computing system, the representation of the differential graph comprises a matrix including indications of one or more metrics.

In any combination of the above embodiments of the computing system, the source of performance variability comprises a function, a process, a thread, or a code portion.

In any combination of the above embodiments of the computing system, the first environment comprises a control environment and the first set of performance data comprises performance data including a performance issue, and the second environment comprises a treatment environment and the second set of performance data comprises performance data excluding the performance issue.

In other embodiments, a computer-implemented method is provided. The method includes generating a prompt including an instruction to identify a source of performance variability associated with performance data based on a set of relevant performance data represented using a differential graph that compares a first set of performance data associated with a first environment with a second set of performance data associated with a second environment. The method also includes providing the prompt as input to a large language model. The method also includes obtaining, in response to the prompt input to the large language model, an indication of the source of performance variability associated with the performance data. The method further includes providing, for display via a graphical user interface, the indication of the source of performance variability. Advantageously, identifying and using the relevant performance data provides a more efficient and effective identification of a source of performance variability, thereby reducing computer resource utilization.

In any combination of the above embodiments of the computer-implemented method, the first set of performance data comprises a first common graph including common traits among performance graphs associated with the first environment, and the second set of performance data comprises a second common graph including common traits among performance graphs associated with the second environment.

In any combination of the above embodiments of the computer-implemented method, the prompt further includes structural data identified via structural graphs generated in association with the performance data.

In any combination of the above embodiments of the computer-implemented method, the source of performance variability comprises a portion of code, a function, a process, a method, a thread, or a combination thereof.

In any combination of the above embodiments of the computer-implemented method, the performance data comprises traces, logs, and/or markers.

In other embodiments, one or more computer storage media having computer-executable instructions embodied thereon that, when executed by one or more processors, cause the one or more processors to perform a method is provided. The method includes identifying relevant performance data comprising a representation of a differential graph that compares a first common graph including a first set of common traits of performance data associated with a first environment with a second common graph including a second set of common traits of performance data associated with a second environment. The method also includes generating a prompt including the representation of the differential graph and a request for an identification of a source of performance variability associated with the relevant performance data. The method also includes based on the prompt, identifying, via a large language model, the source of performance variability associated with the relevant performance data. The method further includes providing, for display, an indication of the source of performance variability associated with the relevant performance data. Advantageously, identifying and using the relevant performance data provides a more efficient and effective identification of a source of performance variability, thereby reducing computer resource utilization.

In any combination of the above embodiments of the media, the first set of common traits is identified by comparing a first set of performance graphs generated for traces associated with the first environment, and the second set of common traits is identified by comparing a second set of performance graphs generated for traces associated with the second environment.

In any combination of the above embodiments of the media, the prompt further includes data associated with structural graphs corresponding with the performance data associated with the first environment and the performance data associated with the second environment.

In any combination of the above embodiments of the media, the source of performance variability comprises a function, a thread, a process, a code portion, or a combination thereof.

In any combination of the above embodiments of the media, the representation of the differential graph comprises a matrix including indications of a metric.

In any combination of the above embodiments of the media, the metric comprises a time metric or a memory metric.

In any combination of the above embodiments of the media, the performance data associated with the first environment comprises performance data exhibiting a performance issue associated with a computing system, and the performance data associated with the second environment comprises data not exhibiting the performance issue associated with the computing system.

### Overview of Exemplary Operating Environments

Having briefly described an overview of aspects of the technology described herein, an exemplary operating environment in which aspects of the technology described herein may be implemented is described below in order to provide a general context for various aspects of the technology described herein.

Referring to the drawings in general, and to FIG. 7 in particular, an exemplary operating environment for implementing aspects of the technology described herein is shown and designated generally as computing device 700. Computing device 700 is just one example of a suitable computing environment and is not intended to suggest any limitation as to the scope of use or functionality of the technology described herein, and nor should the computing device 700 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 7, computing device 700 includes a bus 710 that directly or indirectly couples the following devices: memory 712, one or more processors 714, one or more presentation components 716, input/output (I/O) ports 718, I/O components 720, an illustrative power supply 722, and a radio(s) 724. Bus 710 represents what may be one or more buses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The diagram of FIG. 7 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 7 and refer to “computer” or “computing device.”

Computing device 700 typically includes a variety of computer-readable media. Computer-readable media can be any available media that can be accessed by computing device 700 and includes both volatile and non-volatile, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVDs) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 712 includes computer storage media in the form of volatile and/or non-volatile memory. The memory 712 may be removable, non-removable, or a combination thereof. Exemplary memory includes solid-state memory, hard drives, and optical-disc drives. Computing device 700 includes one or more processors 714 that read data from various entities such as bus 710, memory 712, or I/O components 720. Presentation component(s) 716 present data indications to a user or other device. Exemplary presentation components 716 include a display device, speaker, printing component, and vibrating component. I/O port(s) 718 allow computing device 700 to be logically coupled to other devices including I/O components 720, some of which may be built-in.

Illustrative I/O components include a microphone, joystick, game pad, satellite dish, scanner, printer, display device, wireless device, a controller (such as a keyboard and a mouse), a natural user interface (NUI) (such as touch interaction, pen [or stylus] gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 714 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 700. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 700. The computing device 700 may be equipped with depth cameras, such as stereoscopic camera systems, infrared camera systems, RGB camera systems, and combinations of these, for gesture detection and recognition. Additionally, the computing device 700 may be equipped with accelerometers or gyroscopes that enable detection of motion. The output of the accelerometers or gyroscopes may be provided to the display of the computing device 700 to render immersive augmented reality or virtual reality.

A computing device may include radio(s) 724. The radio 724 transmits and receives radio communications. The computing device may be a wireless terminal adapted to receive communications and media over various wireless networks. Computing device 700 may communicate via wireless protocols, such as code-division multiple access (“CDMA”), Global System for Mobiles (“GSM”), or time-division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

Turning to FIG. 8, FIG. 8 is a block diagram of a language model 800 (for example, a BERT model or Generative Pre-trained Transformer [GPT]-4 model) that uses particular inputs to make particular predictions (for example, answers to questions), according to some embodiments. In one embodiment, the language model 800 corresponds to the response generator 224 of FIG. 2A described herein. In various embodiments, the language model 800 includes one or more encoders and/or decoder blocks 806 (or any transformer or portion thereof).

First, a natural language corpus (for example, various WIKIPEDIA English words or BooksCorpus) of the inputs 801 are converted into tokens and then feature vectors and embedded into an input embedding 802 to derive meaning of individual natural language words (for example, English semantics) during pre-training. In some embodiments, to understand English language, corpus documents, such as text books, periodicals, blogs, social media feeds, and the like are ingested by the language model 800.

In some embodiments, each word or character in the input(s) 801 is mapped into the input embedding 802 in parallel or at the same time, unlike existing long short-term memory (LSTM) models, for example. The input embedding 802 maps a word to a feature vector representing the word. But the same word (for example, “apple”) in different sentences may have different meanings (for example, brand versus fruit). This is why a positional encoder 804 can be implemented. A positional encoder 804 is a vector that gives context to words (for example, “apple”) based on a position of a word in a sentence. For example, with respect to a message “I just sent the document,” because “I” is at the beginning of a sentence, embodiments can indicate a position in an embedding closer to “just,” as opposed to “document.” Some embodiments use a sine/cosine function to generate the positional encoder vector using the following two example equations:

$${PE}_{( pos , 2 i )} = sin ( pos / 1000 {0}^{2 i / {d}_{model}} ) \qquad ( 1 )$$

$${PE}_{( pos , 2 i + 1 )} = cos ( pos / 1000 {0}^{2 i / {d}_{model}} ) . \qquad ( 2 )$$

After passing the input(s) 801 through the input embedding 802 and applying the positional encoder 804, the output is a word embedding feature vector, which encodes positional information or context based on the positional encoder 804. These word embedding feature vectors are then passed to the encoder and/or decoder block(s) 806, where it goes through a multi-head attention layer 806-1 and a feedforward layer 806-2. The multi-head attention layer 806-1 is generally responsible for focusing or processing certain parts of the feature vectors representing specific portions of the input(s) 801 by generating attention vectors. For example, in Question-Answering systems, the multi-head attention layer 806-1 determines how relevant the i^{th} word (or particular word in a sentence) is for answering the question or relevant to other words in the same or other blocks, the output of which is an attention vector. For every word, some embodiments generate an attention vector, which captures contextual relationships between other words in the same sentence or other sequences of characters. For a given word, some embodiments compute a weighted average or otherwise aggregate attention vectors of other words that contain the given word (for example, other words in the same line or block) to compute a final attention vector.

In some embodiments, a single-headed attention has abstract vectors Q, K, and V that extract different components of a particular word. These are used to compute the attention vectors for every word, using the following equation (3):

$$Z = softmax ( \frac{Q \cdot {K}^{T}}{\sqrt{Dimension of vector Q , K or V}} ) \cdot V . \qquad ( 3 )$$

For multi-headed attention, there are multiple weight matrices W^{q}, W^{k}, and W^{v}, so there are multiple attention vectors Z for every word. However, a neural network may expect one attention vector per word. Accordingly, another weighted matrix, W^{z}, is used to make sure the output is still an attention vector per word. In some embodiments, after the layers 806-1 and 806-2, there is some form of normalization (for example, batch normalization and/or layer normalization) performed to smoothen out the loss surface, making it easier to optimize while using larger learning rates.

Layers 806-3 and 806-4 represent residual connection and/or normalization layers where normalization recenters and rescales or normalizes the data across the feature dimensions. The feedforward layer 806-2 is a feedforward neural network that is applied to every one of the attention vectors outputted by the multi-head attention layer 806-1. The feedforward layer 806-2 transforms the attention vectors into a form that can be processed by the next encoder block or make a prediction at 808. For example, given that a document includes a first natural language sequence “the due date is . . . ,” the encoder/decoder block(s) 806 predicts that the next natural language sequence will be a specific date or particular words based on past documents that include language identical or similar to the first natural language sequence.

In some embodiments, the encoder/decoder block(s) 806 includes pre-training to learn language (pre-training) and make corresponding predictions. In some embodiments, there is no fine-tuning because some embodiments perform prompt engineering or learning. Pre-training is performed to understand language, and fine-tuning is performed to learn a specific task, such as learning an answer to a set of questions (in Question-Answering [QA] systems).

In some embodiments, the encoder/decoder block(s) 806 learns what language and context for a word is in pre-training by training on two unsupervised tasks (Masked Language Model [MLM] and Next Sentence Prediction [NSP]) simultaneously or at the same time. In terms of the inputs and outputs, at pre-training, the natural language corpus of the inputs 801 may be various historical documents, such as text books, journals, and periodicals, in order to output the predicted natural language characters in 808 (not make the predictions at runtime or prompt engineering at this point). The example encoder/decoder block(s) 806 takes in a sentence, paragraph, or sequence (for example, included in the input[s] 801), with random words being replaced with masks. The goal is to output the value or meaning of the masked tokens. For example, if a line reads, “please [MASK] this document promptly,” the prediction for the “mask” value is “send.” This helps the encoder/decoder block(s) 806 understand the bidirectional context in a sentence, paragraph, or line at a document. In the case of NSP, the encoder/decoder block(s) 806 takes, as input, two or more elements, such as sentences, lines, or paragraphs, and determines, for example, if a second sentence in a document actually follows (for example, is directly below) a first sentence in the document. This helps the encoder/decoder block(s) 806 understand the context across all the elements of a document, not just within a single element. Using both of these together, the encoder/decoder block(s) 806 derives a good understanding of natural language.

In some embodiments, during pre-training, the input to the encoder/decoder block(s) 806 is a set (for example, two) of masked sentences (sentences for which there are one or more masks), which could alternatively be partial strings or paragraphs. In some embodiments, each word is represented as a token, and some of the tokens are masked. Each token is then converted into a word embedding (for example, 802). At the output side is the binary output for the next sentence prediction. For example, this component may output 1, for example, if masked sentence 2 follows (for example, is directly beneath) masked sentence 1. The outputs are word feature vectors that correspond to the outputs for the machine learning model functionality. Thus, the number of word feature vectors that are input is the same number of word feature vectors that are output.

In some embodiments, the initial embedding (for example, the input embedding 802) is constructed from three vectors: the token embeddings, the segment or context-question embeddings, and the position embeddings. In some embodiments, the following functionality occurs in the pre-training phase. The token embeddings are the pre-trained embeddings. The segment embeddings are the sentence numbers (that includes the input[s] 801) that are encoded into a vector (for example, first sentence, second sentence, and so forth, assuming a top-down and right-to-left approach). The position embeddings are vectors that represent the position of a particular word in such a sentence that can be produced by positional encoder 804. When these three embeddings are added or concatenated together, an embedding vector is generated that is used as input into the encoder/decoder block(s) 806. The segment and position embeddings are used for temporal ordering since all of the vectors are fed into the encoder/decoder block(s) 806 simultaneously, and language models need some sort of order preserved.

In pre-training, the output is typically a binary value C (for NSP) and various word vectors (for MLM). With training, a loss (for example, cross-entropy loss) is minimized. In some embodiments, all the feature vectors are of the same size and are generated simultaneously. As such, each word vector can be passed to a fully connected layered output with the same number of neurons equal to the same number of tokens in the vocabulary.

In some embodiments, after pre-training is performed, the encoder/decoder block(s) 806 performs prompt engineering or fine-tuning on a variety of QA data sets by converting different QA formats into a unified sequence-to-sequence format. For example, some embodiments perform the QA task by adding a new question-answering head or encoder/decoder block, just the way a masked language model head is added (in pre-training) for performing an MLM task, except that the task is a part of prompt engineering or fine-tuning. This includes the encoder/decoder block(s) 806 processing the inputs 803A and/or 803B in order to make the predictions and generate a prompt response, as indicated in 804. Prompt engineering, in some embodiments, is the process of crafting and optimizing text prompts for language models to achieve desired outputs. In other words, prompt engineering comprises a process of mapping prompts (for example, a question) to the output (for example, an answer) that it belongs to for training. For example, if a user asks a model to generate a poem about a person fishing on a lake, the expectation is it will generate a different poem each time. Users may then label the output or answers from best to worst. Such labels are an input to the model to make sure the model is giving more human-like or best answers, while trying to minimize the worst answers (for example, via reinforcement learning). In some embodiments, a “prompt” as described herein includes one or more of: a request (for example, a question or instruction [for example, “write a poem” ]), target content, and one or more examples, as described herein.

The technology described herein has been described in relation to particular aspects, which are intended in all respects to be illustrative rather than restrictive.

What is claimed is:

1. A computing system comprising:
a processor; and
computer storage memory having computer-executable instructions stored thereon that, when executed by the processor, configure the computing system to perform operations comprising:
obtaining performance data indicating performance of a computing system;
analyzing the performance data to identify relevant performance data comprising a representation of a differential graph that compares a first set of performance data associated with a first environment with a second set of performance data associated with a second environment;
generating a prompt including the representation of the differential graph and a request for an identification of a source of performance variability associated with the relevant performance data; and
providing, for display, an indication of the source of performance variability associated with the relevant performance data.

2. The computing system of claim 1, wherein the computing system comprises an application, a computing device, a network, or a combination thereof.

3. The computing system of claim 1, wherein the performance data comprises traces, logs, and/or markers.

4. The computing system of claim 1, wherein analyzing the performance data to identify the relevant performance data comprises:
generating a first set of performance graphs using a first set of performance data corresponding with the first environment and a second set of performance graphs using a second set of performance data corresponding with the second environment;
generating a first common graph that includes a first set of common traits associated with the first set of performance graphs corresponding with the first environment and a second common graph that includes a second set of common traits associated with the second set of performance graphs corresponding with the second environment; and
comparing the first common graph corresponding with the first environment with the second common graph corresponding with the second environment to generate the differential graph.

5. The computing system of claim 1, further comprising:
generating a set of structural graphs; and
including data associated with the structural graphs in the prompt.

6. The computing system of claim 1, wherein the representation of the differential graph comprises a matrix including indications of one or more metrics.

7. The computing system of claim 1, wherein the source of performance variability comprises a function, a process, a thread, or a code portion.

8. The computing system of claim 1, wherein the first environment comprises a control environment and the first set of performance data comprises performance data including a performance issue, and the second environment comprises a treatment environment and the second set of performance data comprises performance data excluding the performance issue.

9. A computer-implemented method comprising:
generating a prompt including an instruction to identify a source of performance variability associated with performance data based on a set of relevant performance data represented using a differential graph that compares a first set of performance data associated with a first environment with a second set of performance data associated with a second environment;
providing the prompt as input to a large language model;
obtaining, in response to the prompt input to the large language model, an indication of the source of performance variability associated with the performance data; and
providing, for display via a graphical user interface, the indication of the source of performance variability.

10. The computer-implemented method of claim 9, wherein the first set of performance data comprises a first common graph including common traits among performance graphs associated with the first environment, and the second set of performance data comprises a second common graph including common traits among performance graphs associated with the second environment.

11. The computer-implemented method of claim 9, wherein the prompt further includes structural data identified via structural graphs generated in association with the performance data.

12. The computer-implemented method of claim 9, wherein the source of performance variability comprises a portion of code, a function, a process, a method, a thread, or a combination thereof.

13. The computer-implemented method of claim 9, wherein the performance data comprises traces, logs, and/or markers.

14. One or more computer storage media having computer-executable instructions embodied thereon that, when executed by one or more processors, cause the one or more processors to perform a method, the method comprising:
identifying relevant performance data comprising a representation of a differential graph that compares a first common graph including a first set of common traits of performance data associated with a first environment with a second common graph including a second set of common traits of performance data associated with a second environment;
generating a prompt including the representation of the differential graph and a request for an identification of a source of performance variability associated with the relevant performance data;
based on the prompt, identifying, via a large language model, the source of performance variability associated with the relevant performance data; and
providing, for display, an indication of the source of performance variability associated with the relevant performance data.

15. The media of claim 14, wherein the first set of common traits is identified by comparing a first set of performance graphs generated for traces associated with the first environment, and the second set of common traits is identified by comparing a second set of performance graphs generated for traces associated with the second environment.

16. The media of claim 14, wherein the prompt further includes data associated with structural graphs corresponding with the performance data associated with the first environment and the performance data associated with the second environment.

17. The media of claim 14, wherein the source of performance variability comprises a function, a thread, a process, a code portion, or a combination thereof.

18. The media of claim 14, wherein the representation of the differential graph comprises a matrix including indications of a metric.

19. The media of claim 18, wherein the metric comprises a time metric or a memory metric.

20. The media of claim 14, wherein the performance data associated with the first environment comprises performance data exhibiting a performance issue associated with a computing system, and the performance data associated with the second environment comprises data not exhibiting the performance issue associated with the computing system.
